(19) United States
(12) Patent Application Publication
(10) Pub. No.: US 2009/0276370 A1
(43) Pub. Date: Nov. 5, 2009

(54) COMPUTER SYSTEM ARCHITECTURE AND COMPUTER IMPLEMENTED METHODS FOR ENHANCED CUSTODY AND PRINCIPAL LENDING OF SECURITIES

(76) Inventors: Scott W. OLSON, Marblehead, MA (US); Brian J. MCLOONE, Marshfield, MA (US); Paul J. FLEMING, Needham, MA (US); Glenn HORNER, Norfolk, MA (US)

Correspondence Address: WILMERHALE/NEW YORK, 399 PARK AVENUE, NEW YORK, NY, 10022, US

(21) Appl. No.: 12/434,408

(22) Filed: May 1, 2009

Related U.S. Application Data
(60) Provisional application No. 61/050,080, filed on May 2, 2008.
(60) Provisional application No. 61/174,367, filed on Apr. 30, 2009.

(51) Int. Cl. G06Q 40/00

(52) U.S. Cl. 705/36 R; 705/37; 705/38

(57) ABSTRACT

A computer system executes a principal lending to lend the securities from lending accounts of an entity to borrowing accounts of the entity, in which the entity acts as a principal. The system includes a computer database storing securities availability information indicating availability of the securities available for borrowing from lending accounts of the entity, and a computer server system implemented by a principal lending computer system. The principal lending computer system configured to receive a short sale indication of a security for a borrowing account, electronically transmit a first transfer instruction to a custody-control computer system to transfer custody of the shorted security from at least one lending account to the principal, and electronically transmit a second transfer instruction to the custody-control computer system to transfer custody of the shorted security from the principal to the borrowing account. A computer implemented method and various alternative embodiments are also disclosed.

### CROSS-REFERENCE TO RELATED APPLICATIONS

This application claims priority under 35 U.S.C. § 119(e) to the U.S. Provisional Patent Application No. 61/050,080, filed on May 2, 2008, entitled “SYSTEMS AND METHODS FOR ENHANCED CUSTODY AND PRINCIPAL LENDING OF SECURITIES,” and U.S. Provisional Patent Application No. 61/174,367, filed on Apr. 30, 2009, entitled “SYSTEMS AND METHODS FOR DOMESTIC AND INTERNATIONAL ENHANCED CUSTODY AND PRINCIPAL LENDING OF SECURITIES,” the contents of which are incorporated herein in their entirety by reference.

### BACKGROUND

Securities lending or stock lending refers to the lending of securities by one party to another. The terms of the loan will be governed by a “Securities Lending Agreement”, where the borrower provides the lender with collateral, in the form of cash, government securities, or a Letter of Credit of value equal to or greater than the loaned securities. As payment for the loan, the parties negotiate a fee, quoted as an annualized percentage of the value of the loaned securities. If the agreed form of collateral is cash, then the fee may be quoted as a “rebate”, meaning that the lender will earn all of the interest which accrues on the cash collateral, and will “rebate” an agreed rate of interest to the borrower.

Securities Lending is legal and clearly regulated in most of the world's major securities markets. Most markets mandate that the borrowing of securities be conducted only for specifically permitted purposes, which generally include;
1. to facilitate settlement of a trade,
2. to facilitate delivery of a short sale,
3. to finance the security, or
4. to facilitate a loan to another borrower who is motivated by one of these permitted purposes.

When a security is loaned, the title of the security transfers to the borrower. This means that the borrower has the advantages of holding the security, just as though they owned it. Specifically, the borrower will receive all coupon and/or dividend payments, and any other rights such as voting rights. In most cases, these dividends or coupons must be passed back to the lender in the form of what is referred to as a “manufactured dividend”. The initial driver for the securities lending business was to cover settlement failure. If one party fails to deliver stock to you it can mean that you are unable to deliver stock that you have already sold to another party. In order to avoid the costs and penalties that can arise from settlement failure, stock could be borrowed at a fee, and delivered to the second party. When your initial stock finally arrived (or was obtained from another source) lender would receive back the same number of shares in the security they lent. The principal reason for borrowing a security is to cover a short position. As you are obliged to deliver the security, you will have to borrow it. At the end of the agreement you will have to return an equivalent security to the lender. Equivalent in this context means fungible, i.e. the securities have to be completely interchangeable. Compare this with lending a ten euro note. You do not expect exactly the same note back, as any ten euro note will do.

Securities lenders are institutions which have access to lendable securities. This can be asset managers, who have many securities under management, custodian banks holding securities for third parties or third party lenders who access securities automatically via the asset holder's custodian. The international trade organization for the securities lending industry is the International Securities Lending Association.

We have determined that the existing securities lending processes can be significantly improved in accordance with the computer architecture and computer processes performed on said architecture, as described below.

### SUMMARY

A computer system executes a principal lending to lend the securities from lending accounts of an entity to borrowing accounts of the entity, in which the entity acts as a principal. The system includes a computer database storing securities availability information indicating availability of the securities available for borrowing from lending accounts of the entity, and a computer server system implemented by a principal lending computer system. The principal lending computer system configured to receive a short sale indication of a security for a borrowing account, electronically transmit a first transfer instruction to a custody-control computer system to transfer custody of the shorted security from at least one lending account to the principal, and electronically transmit a second transfer instruction to the custody-control computer system to transfer custody of the shorted security from the principal to the borrowing account. A computer implemented method and various alternative embodiments are also disclosed.

In some optional embodiments of the invention, the short sale indication is received after the short sale by monitoring a trading computer system to detect short sales by borrowing accounts. In some optional embodiments of the invention, the short sale indication is received before the short sale as a borrow request identifying a security to be borrowed based on the securities availability information.

In some optional embodiments of the invention, the borrow request is received from an investment manager for the borrowing account. In some optional embodiments of the invention, the system electronically receives a securities locate request identifying securities sought for borrowing, and electronically transmits a securities locate request response indicating availability of the securities sought for borrowing.

In some optional embodiments of the invention, the securities locate request is received from an investment manager for the borrowing account. In some optional embodiments of the invention, the lending account and the borrowing account both belong to the same client of the entity. In some optional embodiments of the invention, the securities availability information is stored in the principal lending computer system based on information from lending accounts seeking to participate in principal lending transactions.

In some optional embodiments of the invention, the information from lending accounts seeking to participate in principal lending transactions is received from a lending agent of the entity. In some optional embodiments of the invention, the system initiates a lending transaction of long securities held by the borrowing account to a broker to obtain cash collateral for principal lending transaction. In some optional embodiments of the invention, the system electronically transmits proceeds of sale of the borrowed security to the borrowing account. In some optional embodiments of the invention, the system initiates a purchase of securities for the borrowing account using the sale proceeds.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

FIG. 1 shows a custody and lending model of securities.

FIG. 2 shows a securities lending expansion for an enhanced custody model.

FIG. 3 shows an operation model of an enhanced custody and lending model.

FIG. 4 shows a financing trade example according to embodiments of the present invention.

FIG. 5 shows a model for increasing the number of long positions on attractive securities.

FIG. 6 shows a lending and borrowing model according to embodiments of the present invention.

FIG. 7 shows an enhanced custody model application diagram of the principal lender for the US.

FIG. 8 shows an enhanced custody model application diagram of the principal lender for the US, Europe and the Far East.

FIG. 9 shows the availability processing of the enhanced custody model.

FIG. 10 shows an order management summary process.

FIG. 11 shows an order management summary process with surrogate availability.

FIG. 12 shows a process for generating an investor manager availability file.

FIG. 13 shows an investor manager request file process.

FIG. 14 shows a locate and response file process

FIG. 15 shows an investment manager executed order file process.

FIG. 16 shows an application framework design according to embodiments of the present invention.

FIG. 17 shows a short sale process.

FIG. 18 shows a short sale entry process.

FIG. 19 shows a short sale instruction and settlement process.

FIG. 20 shows a self borrow and a non-self borrow buy-to-cover process.

FIG. 21 shows a process for determining availability and pricing of securities.

FIG. 22 shows a finance trade process.

FIG. 23 shows a contract compare and mark to market process.

FIG. 24 shows an income collection process.

FIG. 25 shows a mandatory corporate action for security exchange process.

FIG. 26 shows a mandatory corporate action for security splits process.

FIG. 27 shows a mandatory corporate action for security spin-off process.

FIG. 28 shows a mandatory corporate action for cash process.

FIG. 29 shows a voluntary corporate action for cash process.

FIG. 30 shows a voluntary corporate action for security exchange process.

### DETAILED DESCRIPTION

Before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the invention be regarded as including equivalent constructions to those described herein insofar as they do not depart from the spirit and scope of the present invention.

For example, the specific sequence of the described process may be altered so that certain processes are conducted in parallel or independent, with other processes, to the extent that the processes are not dependent upon each other. Thus, the specific order of steps described herein is not to be considered implying a specific sequence of steps to perform the process. Other alterations or modifications of the above processes are also contemplated. For example, further insubstantial approximations of the process and/or algorithms are also considered within the scope of the processes described herein.

In addition, features illustrated or described as part of one embodiment can be used on other embodiments to yield a still further embodiment. Additionally, certain features may be interchanged with similar devices or features not mentioned yet which perform the same or similar functions. It is therefore intended that such modifications and variations are included within the totality of the present invention.

In accordance with embodiments of the present invention a portfolio of long securities can be expanded to include additional desirable long securities while undesirable securities are short sold for raising cash collateral. According to embodiments of the present invention assets in a client's account that need to be borrowed are moved within an agent lending system with self-borrow. According to embodiments of the present invention, all securities movement and borrowing is advantageously kept within a custodian system and within the name of the client, without being accessible to a bank.

In accordance with embodiments of the present invention, a computer implemented system and computer architecture provides Alternative Investment Vehicles (“AIV”) that are capable of borrowing securities, such as equity securities (the “Borrowed Securities”) directly, for example, from an agent lender as principal, in connection with their short selling activity. In some embodiments, most of the Borrowed Securities will be sourced (i.e., borrowed), for example, by the agent lender from its agency securities lending program lenders, but at times, the agent lender may borrow securities from other third-party financial institutions (e.g., other agent lender banks or broker dealers) (in each case, “Lenders”). Securities will be borrowed when an AIV requests that they be lent to them by the agent lender. In some embodiments, agent lender will not be taking any position in equity securities or otherwise using such securities for proprietary trading. The agent lender will not generally be holding securities overnight except in the unusual case of a failed trade or based on other limited situations.

The AIVs may be sponsored by, or form part of, a wide variety of U.S. and non-U.S. clients. For example, the AIVs may be investment portfolios of ERISA pension plans or of state and local governmental plans. They may optionally also be separate legal entities, such as registered investment companies under the Investment Company Act of 1940. In addition, the AIVs may be portfolios of, or sponsored by, non-US. investors, such as central banks or monetary authorities. In some embodiments, each instance the AIV will be, or will form part of, a “qualified investor” as defined in Section 3(a)(54) of the Securities Exchange Act of 1934. Each AIV and agent lender may enter in a legal agreement (or amend an existing agreement) that may contain a counter-party/securities lending section under which the agent lender will loan the Borrowed Securities to the AIV and provide for other AIV-related services (the “AIV Agreement”). In some embodiments, the AIV Agreement will optionally include a lien on asset language with respect to principal loans (a factor to be considered during the credit approval process), and/or include on specific lien on asset language if short term cash loans are to be utilized.

Advantageously, the AIV may have a self-borrowing option in accordance with a preferred embodiment of the invention. Specifically, the enhanced custody system including principal lending, includes the option for an AIV to first look in other portfolios of the AIV (or affiliated funds) for the shorted security, where legally permissible. For example, if a large public fund has numerous managed portfolios, the security shorted by the AIV portfolio manager may be held in a portfolio managed by a different manager within the same legal entity.

In such case, the agent lender may effect an internal borrow between portfolios, for example, under the same legal entity, without interposing itself as a principal (referred to as “self-borrows”).

On a trade date, based on the availability of general collateral securities (“GC”) communicated daily by Securities Finance, for example, in an “availability file” or the availability of non-GC securities (or “specials”) communicated via telephone, the AIV (or their investment manager if externally managed) will enter a short sell order with an executing broker. Prior to or on the settlement date, the agent lender, acting as principal, will borrow the required security from its agency lending program (or from other Lenders [i.e., “the street”] if unavailable in the agency lending program). This loan from the agency lending client to the agent lender as principal will be recorded on an agency lending system (e.g., “DML”). The transaction will also be recorded on a standard computer system that tracks the lending and borrowing and performs the functions described herein, such as the principal lending and borrowing system (“Global One”). The “Operational Flows and Risk” section below provides a detailed discussion of the operational flows.

Based upon instructions generated by these systems, the Borrowed Security will move from, for example, the agent lender's Depository Trust Company (DTC) account to a DTC sub-account. Depository Trust Company is a national clearinghouse for the settlement of trades in corporate and municipal securities and performs asset services for its participating banks and broker/dealers. The agent lender's custody system may reflect through book entries that such security is on loan and has left the account of the agency lending client. The Borrowed Security may then be transferred back from the DTC sub-account to the client DTC account.

In accordance with the AIV Agreements, for example, concurrent with the delivery of the Borrowed Securities by the agent lender to the AIVs, the agent lender will receive from the AIVs either cash or securities collateral (“Collateral Securities”) for the loans and pass that collateral back to the lending client in the agency program (or back to the external lender if the Borrowed Security was sourced from the “street”).

In accordance with embodiments of the present invention, the enhanced securities lending system borrows from its agent lending clients and lends these securities to funds utilizing 130/30 strategies and/or other strategies including, but not limited to, those below. Agent lending clients approve the agent lender as borrower. The 130/30 client enters into a borrower agreement with the custodian/agent lender as Principal. Custody of assets never leaves the service model. Accordingly, this self borrowing system and process advantageously leverages existing models to allow clients to borrow securities from themselves first before going to any other source

In some embodiments, the borrow and lending trades will be versus cash. As a result, an asset and corresponding liability will be recorded on the balance sheet. Interest income and expense will be accrued on a daily basis. The 130/30 client will pay the securities finance principal a fee for structuring the transaction. The standard Global One (Sungard) system may optionally be used to implement on-balance sheet transactions

In accordance with the borrower agreement with the Principal/Agent Lender:
Agreement will require lien on asset language beneficial to the Principal/Agent Lender
Principal/Agent Lender provides for the long positions to be committed as collateral
Client uses the proceeds from the short sales to fund additional long buys In accordance with the feature that the custody of assets never leaves Principal's service model with benefits that include:
Corporate actions oversight
Dividend & income payment monitoring
Mark-to-markets & collateralization maintenance
Real-time loan/return/reallocation messaging with custodian
Tax reclaim services

In the enhanced securities lending system of the present invention, in some embodiments, the Securities Finance Principal (SFP) would be the counterparty to the traditional Agency Lending Trade.

Securities Finance Principal would then lend the security out to a Client or possibly to a broker
This means that the lending client only knows the Principal/Agent Lender and the subsequent borrower only knows the Principal/Agent Lender.
The client will only need to approve the Principal/Agent Lender as the counterparty in this trade.
While the Agent Lender is still a facilitator from the perspective of the agent lending part of the trade, but will also act as principal.
Revenue for Securities Finance is based on a fee split between us and the lending client on the earnings. SFP will have earnings based on the spread between the borrow and the loan.

AIVs engage in active extension strategies, which could be set up as, for example, 120/20, 130/30 or 150/50 strategies.

An example of a 120/20 is provided below:
An Investment Manager (IM) will short 20% of a portfolio.
What is going short?
   Going short means that the IM will sell an asset that the portfolio does not own.
The proceeds of the short sale will be used to buy 20% more assets.
Before the portfolio engaged in the short sale, the market exposure was 100%. The combined market exposure remains 100% (100% long minus 20% short plus 20% long) after the short sale and long buy.
For the asset that was sold and not owned, the IM needs to borrow the securities in order to make delivery of the short sale.

In accordance with some embodiments of the invention, the following process is implemented by the enhanced securities lending system of the present invention. Initially, the Securities Finance Principal Desk system (SFP) sends a report to investment managers system (“IM”) showing securities available to borrow or IM will send in a locate file that the SFP will respond to. Based on available securities to borrow the investment manager identifies the securities to short and sends trade order to the Global Management system (“SSGM”). Upon execution SSGM sends trade details back to the IM. Then, the IM instructs the Principal/Agent Lender to sell the security or instructs the SFP to borrow the security. The SFP borrows securities from the Agent Lender and delivers to IM's account in Custody. Custody sends borrowed security to SSGM for trade settlement. Finally, the Custody system maintains positions and delivers trade details to downstream systems.

In accordance with some embodiments of the invention, the following processes are performed by the systems identified below.

The Global One (GI) system is the Book of Records for the Principal Business. All trades and trade activity will be entered into GI. GI interfaces to the Security Movement and Control system (SMAC) for security movements. Client Reporting will be sourced from GI. Finally, GI will also capture and track corporate action and dividend activity.

The Order Management Database system will be utilized to generate Availability to be sent to the IM, process and Respond to Locate requests from the IM, receive in Trade Execution Files from the IM, and generate Trade Blotters for booking loans and borrow to GI and DML.

The DML system has been modified to support the Finance Trades that will be booked in the Agent Lending Program. There will be no Principal Trade Activity booked on DML.

The SLD system will take feeds from GI and carry the data on the SLD database. Eventually, interfaces to other systems will come from SLD for the Principal business. The SLPR system will be utilized for reporting the Principal transactions to the clients or IMs. The SLPR system will also be modified to segregate the Financing Trades from the “normal” agent lending business.

In accordance with some embodiments of the invention, the custodian and/or agent lending computer system handles the following operational tasks for all borrows and loans:
Dividend & income payment monitoring
Mark-to-markets & collateralization maintenance
Real-time loan/return/reallocation messaging with custodian
Corporate actions
   Provide a “Full Service Corporate Actions” model for all clients
   Act on behalf of the client for all corporate actions and income events
   Service the underlying securities “borrowed for” and “lent to” the
   Investment Manager by performing the following:
      1. Make bookkeeping entries to reflect new borrow and loan positions
      2. Debit a client's DDA and deliver the cash proceeds to the Lending Agent or Custodian
      3. Deliver a secondary instrument (i.e. new rights/new shares) to the Agent Lender or Custodian
         Through a brokerage intermediary, purchase the required securities in the market
         Deliver the purchased shares to the Agent Lender or Custodian
         Debit the client's DDA for the cash expense for purchasing the securities on their behalf

In some embodiments of the invention, a computer implemented administration system and method is provided that enables an agent lending system, primarily in support of clients utilizing market neutral strategies, or long-short and enhanced long investment strategies (sometimes referred to as 120/20, 130/30 or 150/50 strategies and referred to herein as “AIVs”, or alternative investment vehicles). These AIVs utilize short securities positions to increase their alpha and to lend securities directly to them (i.e. as principal rather than as agent). By having the AIVs' short positions covered through principal securities lending, the clients are able to avoid prime brokerage services and keep all of their assets custodied with all the attendant services and reporting. The term AIV should be read to include broker-dealers and other conventional borrowers in addition to the alternative investment vehicles discussed above.

In connection with their short selling activity, the AIVs will borrow equity securities (the “Borrowed Securities”) directly from the agent lending system as principal. It is anticipated that most of the Borrowed Securities will be sourced (i.e., borrowed) by the agent lending system from its agency securities lending program lenders, but at times, as a measure of last resort, the agent lending system may borrow securities from other third-party financial institutions (e.g., other agent lender banks or broker dealers) (in each case, “Lenders”). Securities will be borrowed only when an AIV requests that they be lent to them by the agent lending system. Advantageously, the agent lending system is not required to take any position in equity securities or otherwise using such securities for proprietary trading. The agent lender will not generally be holding securities overnight except in the unusual case of a failed trade.

The AIVs will be sponsored by, or form part of, a wide variety of U.S. and non-U.S. clients. For example, the AIVs may be investment portfolios of ERISA pension plans or of state and local governmental plans. They may also be separate legal entities, such as registered investment companies under the Investment Company Act of 1940. In addition, the AIVs may be portfolios of, or sponsored by, non-US. investors, such as central banks or monetary authorities. In each instance the AIV will be, or will from part of, a “qualified investor” as defined in Section 3(a)(54) of the Securities Exchange Act of 1934.

In some embodiments, each AIV and agent lender using the agent lending system will enter in a legal agreement (or amend an existing agreement) that will contain a counter-party/securities lending section under which the agent lender will loan the Borrowed Securities to the AIV and provide for other AIV-related services (the “AIV Agreement”). Optionally, an AIV Agreement lien on asset language will be provided with respect to principal loans (a factor to be considered during the credit approval process), and/or a specific lien on asset language if short term cash loans are to be utilized, per below.

Prior to describing the principal lending transaction, it is important to note that the enhanced custody principal lending system includes the option for an AIV to first look in other portfolios of the AIV (or affiliated funds) for the shorted security, where legally permissible. For example, if a large public fund has numerous managed portfolios, the security shorted by the AIV portfolio manager may be held in a portfolio managed by a different manager within the same legal entity. In that case, the agent lender and agent lending system would effect an internal borrow between portfolios under the same legal entity without interposing itself as a principal (referred to as “self-borrows”). Self-borrows will, with many clients, be the first step in the process prior to borrowing from the agent lender.

The principal loans to the AIVs by the agent lender and the related trade execution and ancillary custodial services are discussed herein. The following discusses the various parties' roles and responsibilities in greater detail;

On trade date, based on the availability of general collateral securities (“GC”) communicated daily by Securities Finance in an “availability file” or the availability of non-GC securities (or “specials”), the AIV (or their investment manager if externally managed) will enter a short sell order with an executing broker. Prior to or on settlement date, the agent lender using the agent lending system, acting as principal, will borrow the required security from its agency lending program (or from other Lenders [i.e., “the street”] if unavailable in the agency lending program). This loan from the agency lending client to the principal will be recorded on the agency lending system (“DML”). The transaction will also be recorded on the principal lending and borrowing system (“Global One”). See additional discussion below for detailed discussion of Global One and operational flows.

Based upon instructions generated by these systems, the Borrowed Security will move from the client Depository Trust Company (DTC) account to the agent lender's DTC sub-account. The DTC is a national clearinghouse for the settlement of trades in corporate and municipal securities and performs asset services for its participating banks and broker/dealers. This DTC sub-account is a sub-account of the agent lender's “997” DTC account. The agent lender's custody system will reflect through book entries that such security is on loan and has left the account of the agency lending client. The Borrowed Security will then be transferred back from the DTC sub-account to the agent lender's client DTC account. The agent lender's custody system, through book entries, will reflect the new long positions in the AIV's custody account. It will also reflect the fact that the AIV has a security to borrow. The Borrowed Security will then be delivered out of the agent lender's client DTC account to the broker's DTC account to settle the short sale. The agent lending custody system will reflect through book entries the settlement of this transaction in the custody account of the AIV.

The AIV's short sales will not be carried on the executing broker's books, but rather will be accounted for on the agent lender's system. Proceeds from these short sales will be credited to the AIVs DDA (which may then be swept into a sweep vehicle) and, in many cases (if not swept into a sweep vehicle), used by the AIVs to simultaneously purchase additional long exposure.

In accordance with the AIV Agreements, concurrent with the delivery of the Borrowed Securities by the agent lender to the AIVs, the agent lender will receive from the AIVs either cash or securities collateral (“Collateral Securities”) for the loans and pass that collateral back to the lending client in the agency program (or back to the external lender if the Borrowed Security was sourced from the “street”).

In most cases, cash will be the applicable collateral. Cash will be raised in most instances by the AIVs lending their securities in the agency lending program or from other portfolios in the same legal entity. To the extent an AIV raises cash, such loans will be referred to as “Financing Transactions” and will generally be transacted separately from the agency program and its queue. The AIV Agreement will have language that can identify on a daily basis those securities that will be removed from “Available Securities” (as that term is defined in the Securities Lending Authorization Agreement) and will be available for Financing Transactions. Cash raised through Financing Transactions and needed as collateral will be recorded on the agent lender's principal books (e.g., the standard Global One system) and will be delivered via an AIV Cash Collateral Account, through the agent lender as principal, to the underlying lenders and invested by the agent lender in the lending client's cash collateral investment account. The rebate fee (or “rebate rate”) payable by the agent lender to the AIV will be comprised of a portion of the rebate fee received from the Lender.

In cases where a Lender is in agent lender's agency lending program, the agent lender, as agent, is authorized by Lender to invest cash collateral in a separately managed account, in an investment pool managed by the agent lender, or in an external fund. Lender is entitled to any investment return on the cash collateral. All investment risk with respect to the cash collateral is borne by Lender. Lender is generally required to pay the agent lender a fee for arranging the loan (an agency lending fee) and pay the principal borrower a fee for the use of the cash collateral (the “Rebate Fee”).

In limited instances where Financing Transactions cannot be effected (e.g., late in the day) and AIVs have no other cash available for collateral purposes, the AIVs may borrow cash from the agent lender intraday or overnight to meet their cash collateral needs. These short term loans would be collateralized by a pledge of the AIV's assets, and perhaps by other custody assets (and short-term cash loans will not be made to an AIV. To the extent that such pledged assets are not “margin stock” and are sufficient to cover the short term loans, the Federal Reserve's Regulation U (pertaining to the extension of credit by banks, “Reg. U”) is not applicable. If the short term loans are collateralized by “margin stock” (i.e., equity securities traded or listed on national stock exchanges, mutual fund shares [other than certain excluded mutual funds], OTC NMS securities, and debt securities that are convertible into margin stock or are subject to warrants exchangeable into margin stock), which may be the case, Reg. U would possibly apply. These short term loan proceeds will be specifically earmarked for cash collateral needs.

In some embodiments, the AIVs will agree in the AIV Agreement to execute and deliver all necessary documents and/or give all necessary instructions to ensure that the agent lender either receives title to Collateral Securities or has a first security interest in the Collateral Securities (a “pledge” or “security interest”). On certain occasions, especially with respect to non-U.S. AIVs, Collateral Securities may be transferred outright, with full transfer of title and free of all encumbrances. It is expected that in most instances, however, especially in the case of AIVs established under U.S. law, that the AIVs will pledge a portion of their long securities and that agent lender will obtain a security interest in those Collateral Securities. And specific to the U.S. market, Securities Finance intends to obtain rehypothecation rights from the AIVs in connection with pledged Collateral Securities, to the extent legally possible, and then re-pledge such securities to the underlying lenders (e.g., lending client in the agency lending program or other lenders, all “Lenders”) of the principal loan.

As discussed above, the present invention provides clients and/or systems with AIVs and other portfolios or funds custodied within the same legal entity (e.g., large public funds) a service and/or process whereunder the custodian would process an internal transfer (or “loan”) from one portfolio or fund to another. Thus the client is able to use idle long positions to cover their own short sales. In addition to the custodian earning incremental processing revenue from this activity, these self-borrows are not flowing through the custodian as a principal and thus do not go onto the custodian's balance sheet. To the extent that there are leverage ratio or tangible common equity limitations, this will support AIV short sales at a greater level than previously thought.

As previously noted, initially SFP will be engaging in transactions with cash collateral being utilized throughout the transaction. These trades will consist of three legs:

SFP will be a borrower of securities and post cash collateral to the agent lender, generally at 102% of the value of the securities borrowed. Therefore, if SFP were to post 102% cash collateral a risk based capital charge would only be incurred on the 2% of excess cash collateral

The second leg of this transaction is the loan of securities from SFP to the AIV, whereby 102% cash collateral is received. SFP would assign the risk weight of the cash collateral to this leg of the conduit transaction. The risk weight appropriate to cash is 0%.

The final leg of the transaction is the financing trade, which is utilized to enable the AIV client to raise the cash necessary to collateralize the securities borrow. This transaction will take place under an agent lending agreement, whereby the agent lender will lend securities and receive cash back as collateral. For the cash collateral received, risk based capital will be calculated using existing VaR (value-at-risk) modeling.

Thus, under a cash-based transaction, only the securities borrow from the agent lender would have a Risk Based Capital impact, with the risk weighted asset being equal to 100% of excess cash collateral provided.

In some embodiments, SFP may undertake transaction utilizing non-cash collateral. These transactions would have two legs.

In the first leg, where SFP borrows securities and post securities as collateral the SFP would incur no risk based capital impact.

In the second leg, SFP loans the securities to the AIV and receives securities as collateral. Therefore, in this scenario, if the collateral is composed of treasuries or other qualifying collateral, the risk weight shall be 0%; otherwise it shall be 100% or, if the counterparty is a qualifying broker-dealer, 20%.

In some embodiments, a loan of cash, secured by securities, can qualify for the securities borrowing rule so long as it meets the following requirements at the time the loan is made:
(a) The lien is over securities includable in the trading book that are liquid and readily marketable (this should not be an issue, as virtually all equity position held by AIVs will be trading book eligible);
(b) the overdraft/loan is marked to market daily (this should not be an issue since it will at most be an overnight loan);
(c) the overdraft/loan is subject to daily margin maintenance requirements (again, this should not be an issue since overnight); and
(d) the overdraft/loan is done on an overnight basis, is unconditionally cancelable, or is effectively exempt from automatic stay in bankruptcy (again, not an issue since overnight).

In the enhanced custody model, principal lending transactions will be done initially with custodied clients and all lending will be against cash collateral. However, non-cash collateral trades may optionally be used. The principal lender, be it SSBT or an SSC subsidiary, will also have, in most cases, the benefit of a lien on assets against the AIVs.

It will also be necessary to approve credit limits on behalf of the principal for lending to the AIV funds. SF Credit & Risk has recommended to ERM setting up a new facility in the dealing book that will denote that the facility is on behalf of the principal rather than the agent program. SF Credit & Risk will need to recognize the exposure represented by the margin that the principal is giving to the lender (through the agent). The SEC requires that broker-dealers record and monitor the risk associated with margin pledged to lenders. With respect to BASEL, Securities Finance will initially be e-mailing daily loan, collateral and margin positions to ERM technology for their manual input into the RDR system. These feeds for BASEL purposes optionally can be automated (e.g., with FTP transfers).

The settlements of principal borrows and loans, processing voluntary and involuntary corporate actions, daily marking to market, recall management and oversight of reconciliation of securities movements/positions will be managed according to the following:
Transaction Settlements: Transactions will be based on the standard local market settlement cycle in which the trades are settling in.
Corporate Actions: Processing and general oversight of all corporate actions functions associated to the Securities Finance Principal product will use the industry standard, for example, “Prime Broker-like Full Service Corporate Actions” service model to all of the Principal's clients.
The scope of the “Full Service Corporate Actions” service model is inclusive of all participating Principal clients and the underlying securities which they borrow from the SF Principal Lending team.
Mark to Markets: SFP Operations will manage its collateral exposure through the daily mark to market process for all open borrows and loans with participating lenders and AIVs. Mark to markets will be based on industry practice for margin and rounding parameters, using the Loanet LAMS system for automated marks.
Recall Management: SFP Operations will be responsible with assisting SFP Trading for the management of recalls issued to the Principal.
Security Reconciliation: Security and transactional based reconciliations between the interactions with the lending agent, the lending agents custody system, the AIV custody records and the borrow and loan records internal to Global One. The main goal of these comparison points is to ensure that all transactions are properly being executed and to provide the principal team with the requisite tools needed to proactively search for unannounced short or long transactions with participating AIVs.

Of these functions within SFP Operations, corporate action processing is the most critical, both in terms of potential losses and exception processing for the Securities Finance Division. The proposed SFP operating model for monitoring and managing corporate actions associated with principal lending differs from what Securities Finance (“SFA”) currently processes on behalf of its beneficial owners. The main difference is that, in the Agency Program, Securities Finance simply sends corporate action instructions to the borrowers, while for corporate actions hereunder, the SFP Operations group will be treated like a participating borrower by the SFA Operations group. Thus SFP Operations will receive, and acknowledge the receipt of, the corporate action instructions and will have to act accordingly. The SFP Operations group will assume an active role in processing the corporate action and will do so on behalf of the AIV.

SFP Operations will take the required action as instructed by the client election notification from SFA Operations and subsequently charge its client, being the AIV, for the expense incurred for completing and processing the corporate action. By SFP Operations taking an active role for corporate actions, it allows the same degree of transparency that a Prime Broker provides an investment manager for corporate actions. SFP Operations will provide the support services an AIV expects for his principal based borrowing activity.

The general corporate action service model is as follows:
1. Responsibilities to the AIV
   a. Through a “Power of Attorney or the AIV Agreement,” SFP Operations will act on behalf the participating AIV for all corporate actions.
   b. SFP Operations will report the requisite corporate action details and resulting processing actions to the participating AIV in a timely manner.
2. Responsibilities to Participating Lender(s)
   a. For all reconciled and confirmed corporate actions, pay the participating lender(s) all cash and securities obligations on market pay date.
   b. SFP Operations will report the requisite corporate action details and resulting processing actions to the participating Lending Agent or Custodian in a timely manner.

SFP Operations will take one or a combination of the following three process actions for each corporate action liability on behalf of the participating AIV for each corporate action obligation owed to the participating Lending Agent:
1. Make book-keeping entries to reflect new borrow and loan positions.
2. Debit an AIVs DDA and deliver the cash proceeds to the Lending Agent or Custodian.
3. Deliver a secondary instrument (e.g., rights, new shares, etc.) to the Agent Lender or Custodian.
   a. Through a brokerage intermediary, purchase the required securities in the market.
   b. Deliver the purchased shares to the Agent Lender or Custodian.
   c. Debit the AIVs DDA for the cash expense for purchasing the securities on their behalf.

With respect to these principal loans most of the cash and securities movements will be wholly in the custodian/agent lender's control, utilizing the custodian/agent lender's systems and books and records. Also, from both an operational and legal standpoint, the principal lending activity described herein is the equivalent of riskless principal trading. The custodian/agent lender will not initiate a principal lending transaction unless it has obtained a commitment from both parties to the transaction. Thus, any securities borrowed by the agent lender will be immediately loaned out to the ultimate borrower, and any collateral posted by the ultimate borrower will be immediately posted to the account of the Lender.

The following figures present various processes using different acronyms. The acronyms' definitions are presented below:

“SFA” is an agent lending running desk, e.g., the agent lending desk.
“SFP” stands for security finance principal and supports the enhanced custody model product. It corresponds to the ones borrowing the securities and responding with the locate requests.
“IM” is an investment manager.
“IR” stands for Information Recording,
“OMD” stands for Order Management Database.
“Phone” means that there is a person connected to the phone.
“Global One” is a book of records system for the principal desk. It carries all the borrows from the agent lenders and performs end-to-end processing.
“MCH” stands for Multi-Currencies Horizon and is a bank accounting system.
“DML” is the agent lenders book of records and is used for the agent running desk.
“SB” stands for self-borrowing.
“NSB” stands for non self-borrowing.
“SMAC” stands for security movement and control.
“DTC” stands for Depository Trust Company.

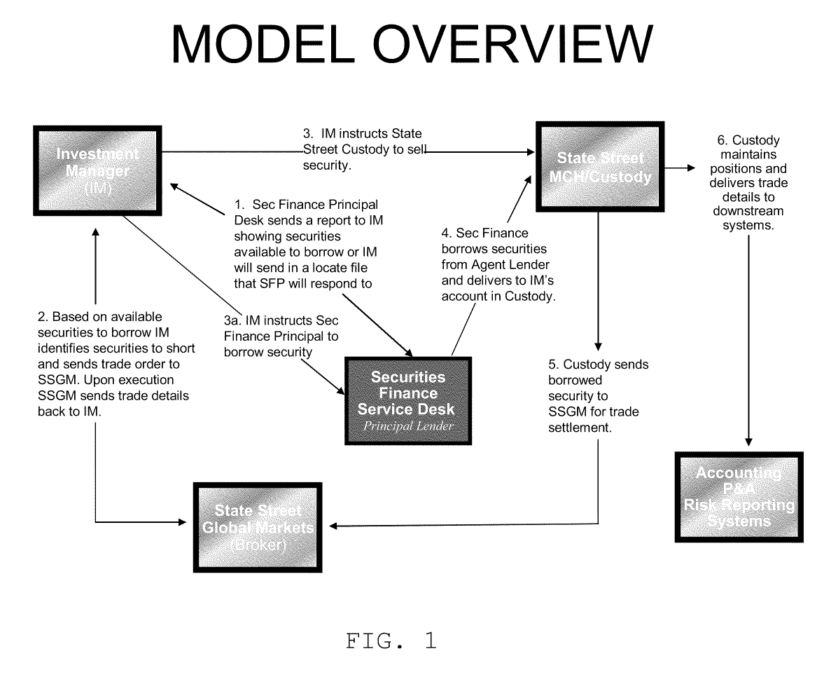

FIG. 1 shows a custody and lending model where a securities finance principle desk may send reports with available securities for borrowing to investment managers. Alternatively, the securities finance principle desk may respond to locate files for specific securities sent by investment managers. Based on available securities, investment managers may identify securities for short selling and may send trade orders to broker dealers. Upon execution of the trade orders, trade details are sent back to investment managers. Investment managers may instruct a custody system to sell the securities. Alternatively, investment managers may instruct the securities finance principal desk to borrow securities identified by the investment managers. The securities finance principal desk may borrow the securities from an agent lender system and deliver them to the investment manager's account in a custody system that may send the borrowed securities to a broker dealer for trade settlement. The custody system maintains the positions and may deliver the trade details to accounting and risk reporting systems.

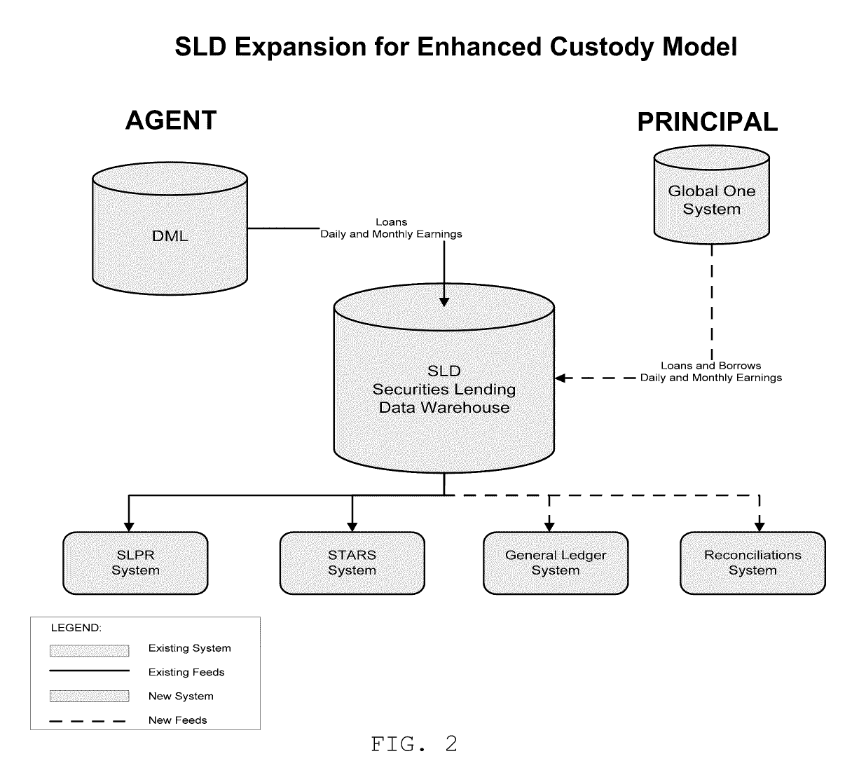

FIG. 2 shows a securities lending expansion to a custody system. The expansion comprises a securities principle system, a reconciliations system, and a general ledger system. The securities principle system loads daily and monthly earnings from loans and borrows to a securities lending database. The securities lending database is coupled to a general ledger system for bookkeeping and a reconciliations system for trade settlements.

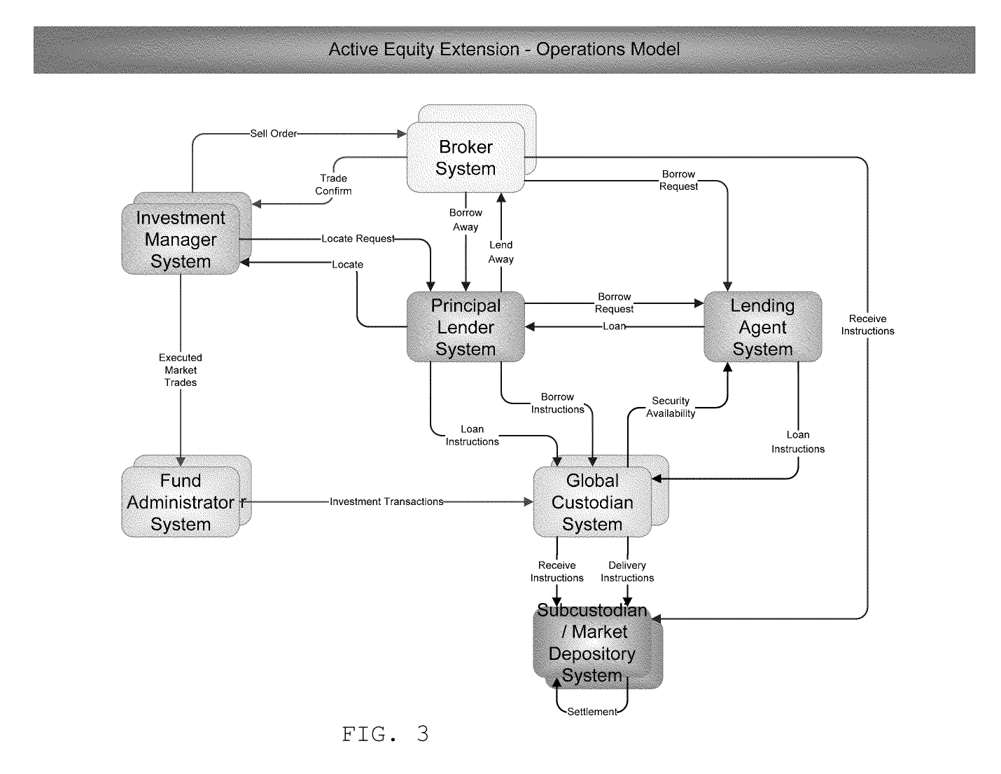

An operational model of the equity extension is shown in FIG. 3. The principal lender system receives locate requests from investment managers for securities and responds with locate responds. The investment manager may send sell orders to broker dealers and receive trade confirmations back. The investment manager may also send information on executed market trades to a fund administrations system.

The principal lender system may send borrow requests for securities to an agent lender system and receive the borrowed securities back. The principal lending system may also lend securities to the broker dealer and borrow from the broker dealer. The broker dealer may also send borrow instructions to the agent lender system. The principal lending system may send borrow and lend instructions to a custodian system. The custodian system may also receive information on investment transactions from the fund administrations system. The custodian system may also send security availability instructions to the agent lender system and receive loan instructions back. Further, the custodian system may also send receive and delivery instructions to a subcustodian or market depository system that performs settlements on the borrowed securities and may also receive instructions from the broker dealer.

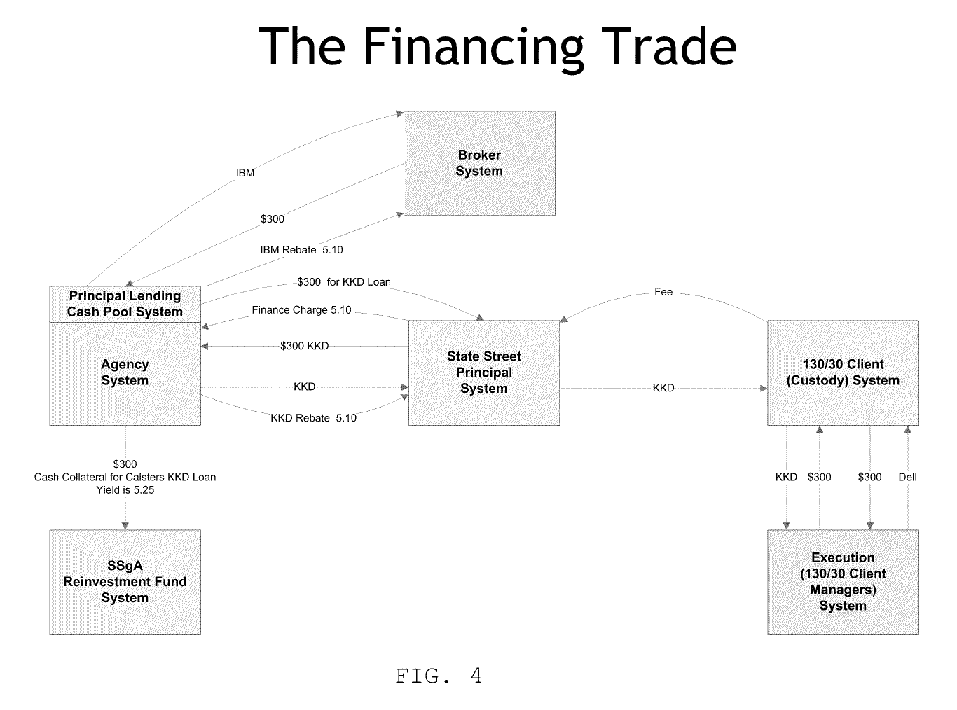

FIG. 4 is an all encompassing diagram to show an exemplary principal lending process for a 130/30 client in accordance with some embodiments of the invention. The client has requested to borrow the KKD security. In this embodiment, the client has sold KKD to the street, but in order to deliver the security, the client needs the security to be transferred to the principal to get delivery. In this example, the client gets the $300 in cash from the person they sold the security to. The client takes the $300 and buys Dell securities. Accordingly, the client is short KKD, long Dell and the client's cash is flat or $0. The principal borrows KKD, and gives the agent lender the $300, and the agent lender in turn invests the $300 on behalf of the client. At the end of the transaction, the principal is short $300, and has not received the cash from the client. The client in the account does not have cash. The principal takes a loan the client has made, and the cash from the loan (e.g., IBM to broker), and broker returns the $300 to the agent. The agent lender sends the $300 to principal as the collateral on behalf of the client, resulting in the self-financing for the KKD of the present invention. The KKD and/or IBM rebate represents the return on the cash investment.

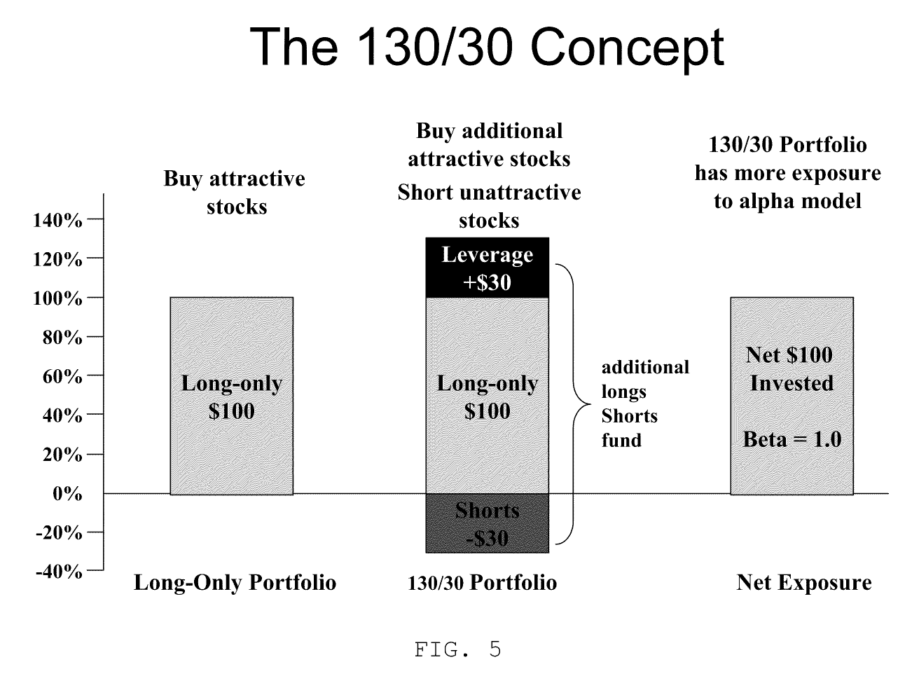

FIG. 5 shows an example of a process for using existing long positions to raise cash collateral through a securities agent lending program. The client has a long-only portfolio worth $100. Through a securities agent lending program the client portfolio can be expanded to include additional attractive long securities worth $30. At the same time, unattractive securities worth $30 are short sold so that cash collateral is raised and the portfolio gets additional exposure.

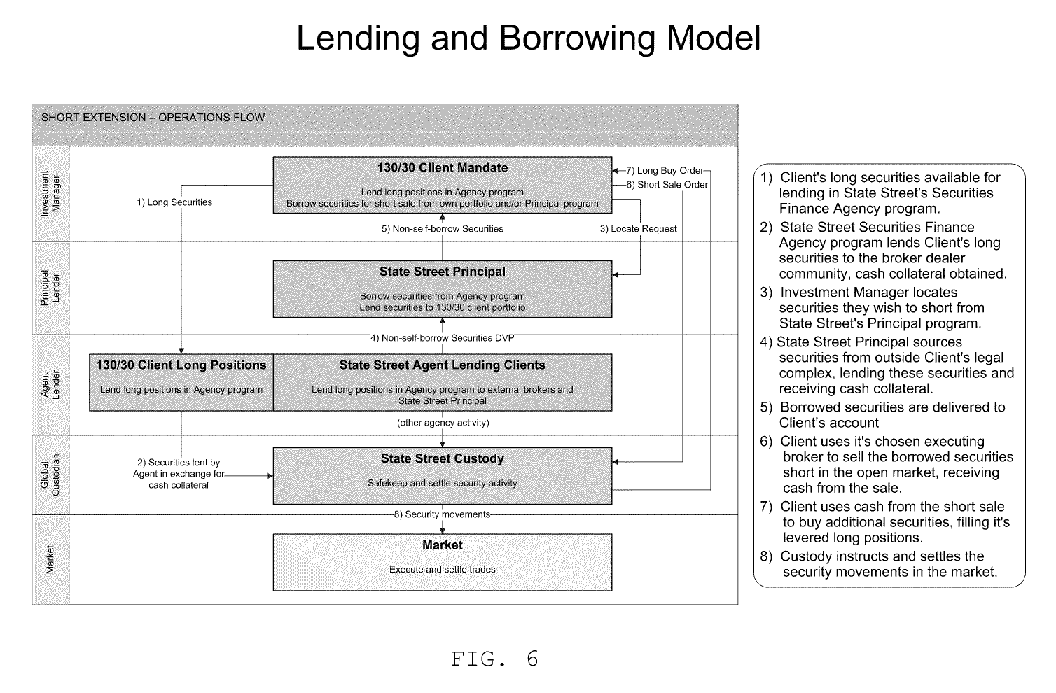

FIG. 6 shows a lending and borrowing model according to embodiments of the present invention. A clients long-term securities are made available for lending in a Securities Finance Agency program. The Securities Finance Agency program is able to lend the long securities to broker dealers to raise cash collateral for the client. Additionally, an investment manager can request securities to short from a principal program. The Securities Finance Agency program lends the securities and receives cash collateral. The borrowed securities are then delivered to the client. Through a broker dealer, the client can short sell the securities to receive cash from the sale. The cash obtained from the sale is used for buying additional securities to fill the clients levered long positions. Finally, the custodian system settles the security movements in the market.

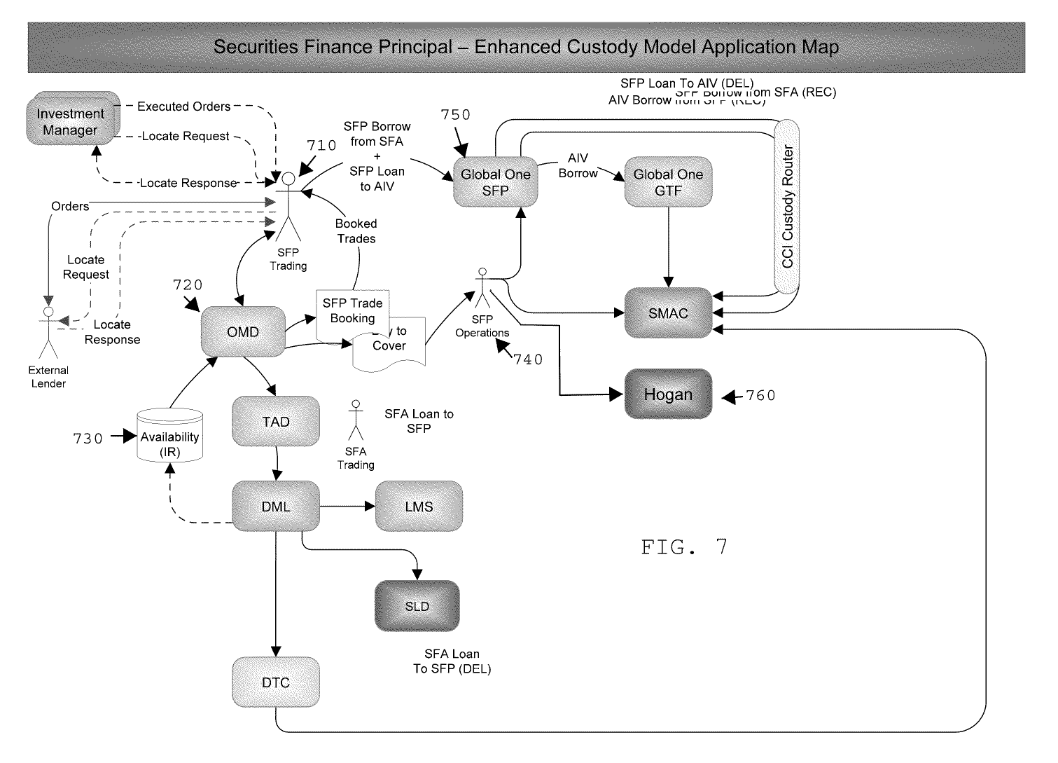

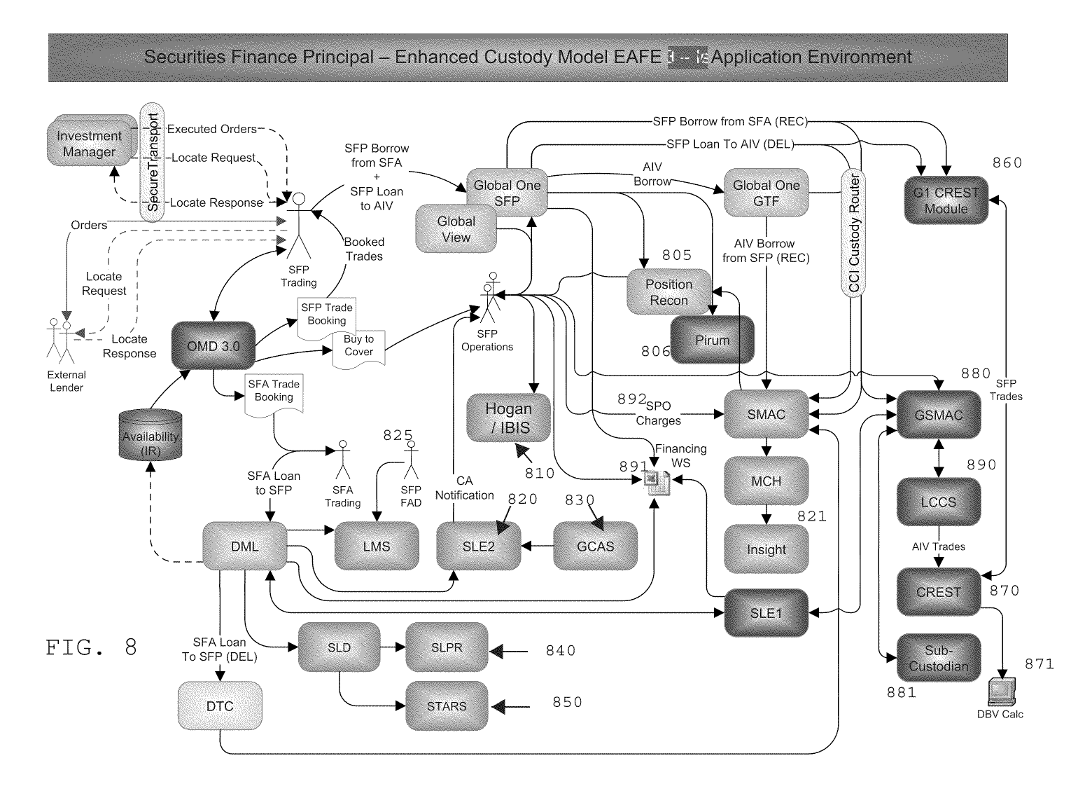

FIGS. 7 and 8 show a processing flow where parts of the processing are manual as specified by human icons. As shown in FIG. 7, the investment manager sends, for example, locate requests or executed orders. A human operator 710 manually books entries into Global One and interacts with an automated management database 720 (OMD).

The automated management database 720 is also coupled to a trade automated entry (TAD) system which books trades automatically into the agent lenders book of records (DML). Availability of securities is provided by an availability database 730, which is an investment reporting (IR) database. A liquidity matching system (LMS) is connected to the DML and performs matching for the agent writing desk and providing information, for example, about available cash in specific vehicles. The DML is also connected to another standard reporting database stock loan data (SLD) and to the depository trust company (DTC). The actual security movement takes place in the DTC.

The automated management database 720 may generate SFP trade bookings and buy-to-cover sheet reports. SFP Operations 740 receive buy-to-cover sheet reports and may also perform entries into Global One SFP 750. Global One SFP 750 is a security finance principle lending system and through a common custodial interface (CCI) communicates to a security movement and control system (SMAC). Global One SFP 750 may also communicate to SMAC through a global trade flow (GTF) module.

SFP operations 740 are also connected to a cash movement system (Hogan) 760. Hogan is an outside bank system manages the bank cash movements.

FIG. 8 provides additional information about processing in international markets (Europe and the Far East) as well as national markets.

The outside bank cash management system 810 is expanded with IBIS to facilitate cash movement for non-US currency. The SLE2 820 system is another lending system that can deal, for example with shortcomings in the daily operation of the business. The GCAS 830 system is a global corporate action system which feeds the system with corporate action information. The SLD reporting database is coupled to a client reporting system (SLPR) 840 and a risk analytics system (STARS) 850.

The GI CREST module 860 facilitates communication with CREST 870 which is the UK system. The GI CREST module is used for moving securities from and to the UK. GSMAC 880 is the global security movement and control system, which is custody system for all non-US securities. LCCS 890 is the custody system used to communicate with CREST 870.

A sub-custodian system 881 may be used to move securities in markets where the system does not offer custody services. In some cases a sub-custodian is hired for convenience or for legal purposes. Insight 821 is another client reporting system. Position Recon 805 is a secondary agent lending system that deals with shortcomings of the order amounts. Attached to Position Recon is Pirum 806 which is a contract repair system for non-US contract repairs.

The Financing worksheet (WS) 891 may provide information on deficits or assets in cash to determine how much cash may need to be raised for a particular client. SPO charges 892 are charges that go out through SMAC to the DTC which is a DTC charge for mark-to-markets determination. SFP FAD 825 is the financial accounting division that performs cash management. Finally, FIG. 8 shows, a DVB calculator 871 which can calculate the collateral amount required at the end of the day.

Funds may borrow from their own portfolios as Self-Borrows (SB) and from other agency clients through the securities finance principal as non-Self Borrows (NSB). The securities finance principal will first attempt to source their NSB requirements from Securities Finance Agency (SFA), but if they are not available from the Agency program, then the securities finance principal will borrow externally.

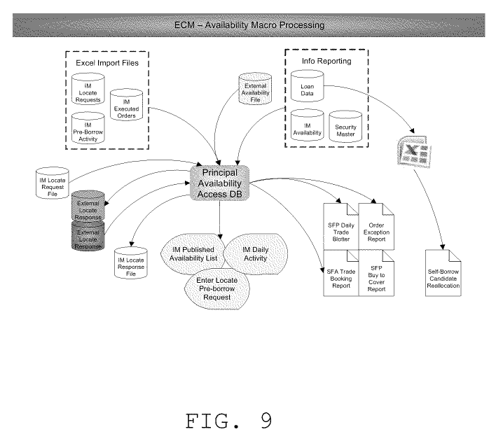

The securities finance principal trading desk will receive a request to locate securities or a notification that the investment manager has sold short may need to determine how to source these shares. To make the sourcing decision and record the actions taken, a database, as shown in FIG. 9, is needed to manage this function.

The database will include the ability to:
View published IM Availability
Import and apply external availability file
Import IM Locate Request file
Record IM locate and pre-borrow requests
Record non-client self-borrow activity
Record IM short sales
Determine availability for an Investment Manger, AIV, Security and Source
Generate a Locate Request file to send to the external sources for those shares not available from SFA.
Import the external broker Locate Response file and append to SFP availability
Generate Locate Response files to the investment manager
Identify non-self borrow loans to reallocate to make shares available for a self borrow
Report loans that need to be booked as a result of a pre-borrow or short sale execution
Reconcile IM executed orders with the published availability, locate and pre-borrow transactions
Report Buy to Cover transactions for SFP Operations
Record actual quantities booked and loan numbers

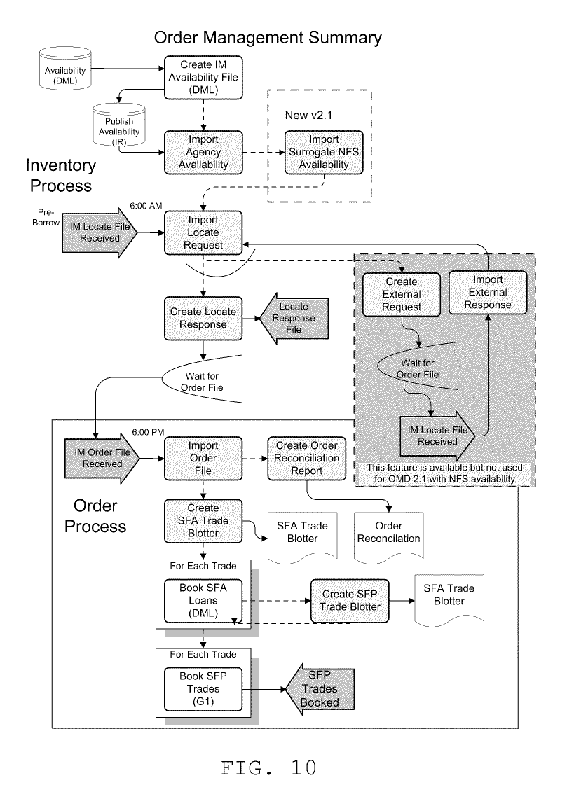

FIG. 10 shows an order management summary flow, describing the inventory process and the order process. In the inventory process, an investment manager availability file is created and the agency availability is imported. An investment manager locate file is received and imported in the agent lender system. Finally, a locate response is created and the agent lender waits for the order file that corresponds to the locate response.

In the order process, when an investor manager file is received, an order file is imported. An order reconciliation report is created that reconciles the order. Additionally, from the imported order file, an SFA Trade blotter is created and for each trade SFA loans are booked in the DML system and SFP trades are booked in the Global One system.

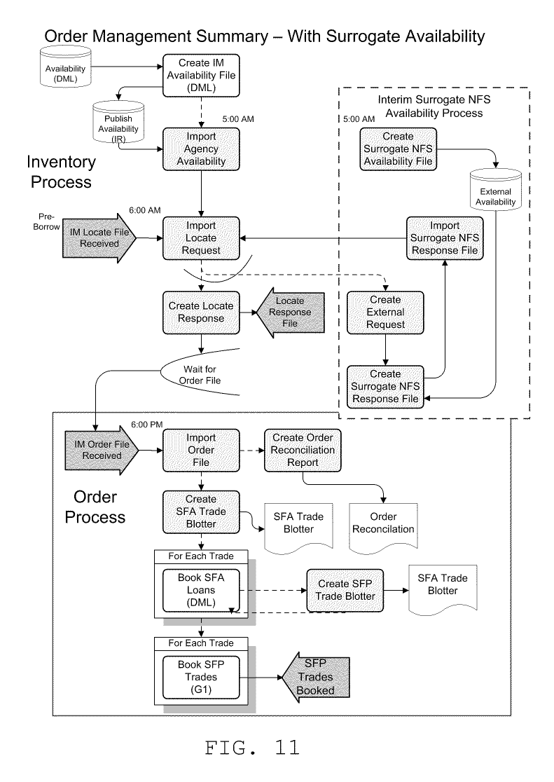

FIG. 11 shows an order management summary flow, as described in FIG. 10 with surrogate availability. The interim surrogate NFS availability process creates a surrogate NFS availability file. After the external availability is checked, a surrogate NFS file is created and imported in the locate request.

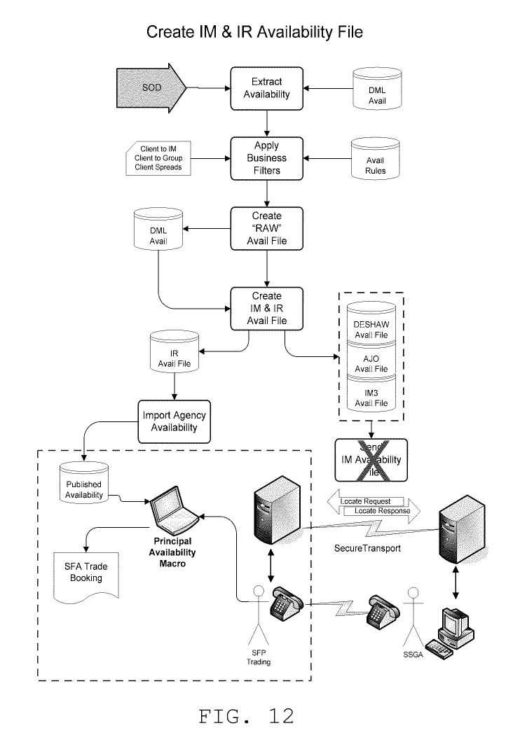

FIG. 12 illustrates how an investor manager availability file is created, published to the investment manager, and used by the Principal Availability macro to manage IM borrowing requests. The availability is built in batch on the mainframe and is detailed in the AIV investment manager availability file. While the batch availability process creates availability files for each investment manager, the files are no longer published to the IM as originally planned. The IM will rely on the Locate and Response process instead of the published availability.

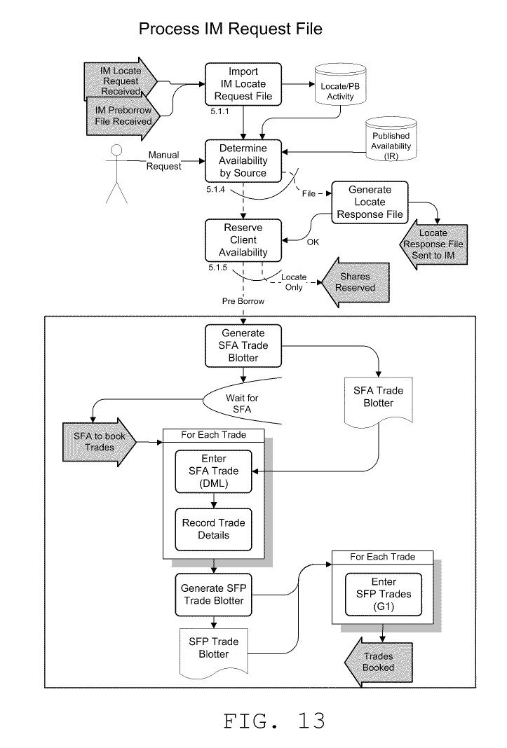

FIG. 13 illustrates an investor manager request file process. An IM request file may be a Locate or a Pre-borrow. When a file is imported to the OMD or user enters a specific request, the OMD attempts to allocate shares to each request. If accepted, the shares are reserved. If the shares are being pre-borrowed then the process will continue with the SFA and SFP loan booking process.

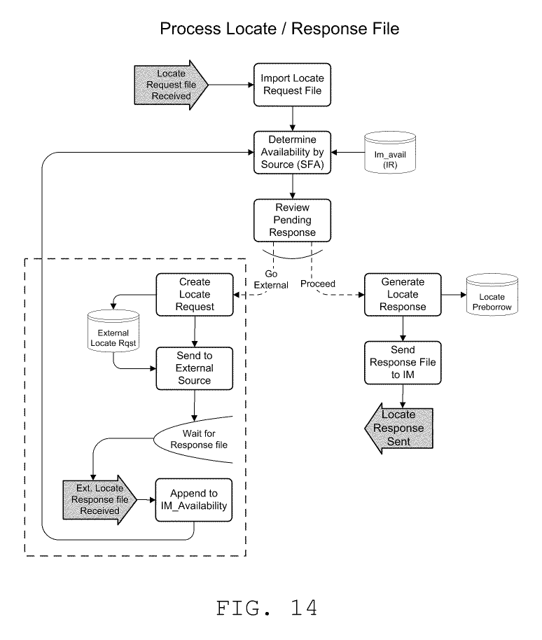

FIG. 14 illustrates a request for external availability process. After the availability is determined, the response is reviewed and the agent lender may decide to go external. An additional locate request to an external source is then created and the external source responds. According to the external source response, the investor management availability is updated. If the original response does not go external, a locate response is generated and a response file is sent to the investment manager.

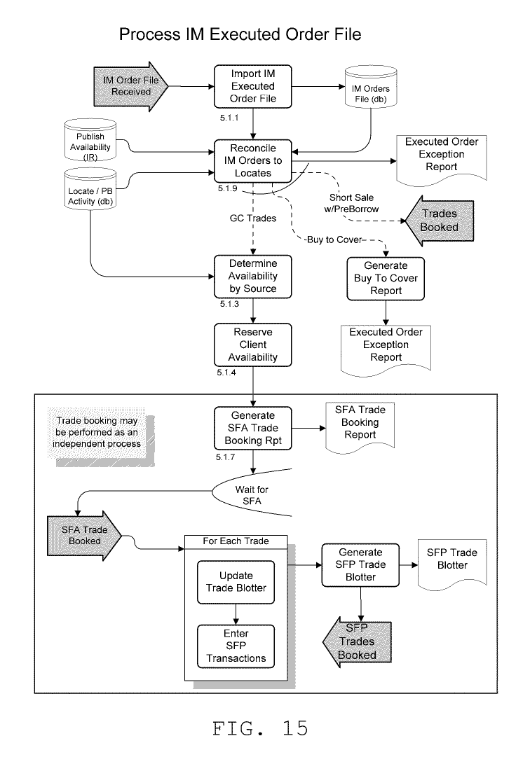

FIG. 15 shows an investor manager executed orders file process. An IM Executed Orders file is imported to the OMD, the transactions are reconciled against their locates and pre-borrows and then shares are allocated (reserved) to it. All new trades, without pre-borrows, will continue with the SFA and SFP loan booking process.

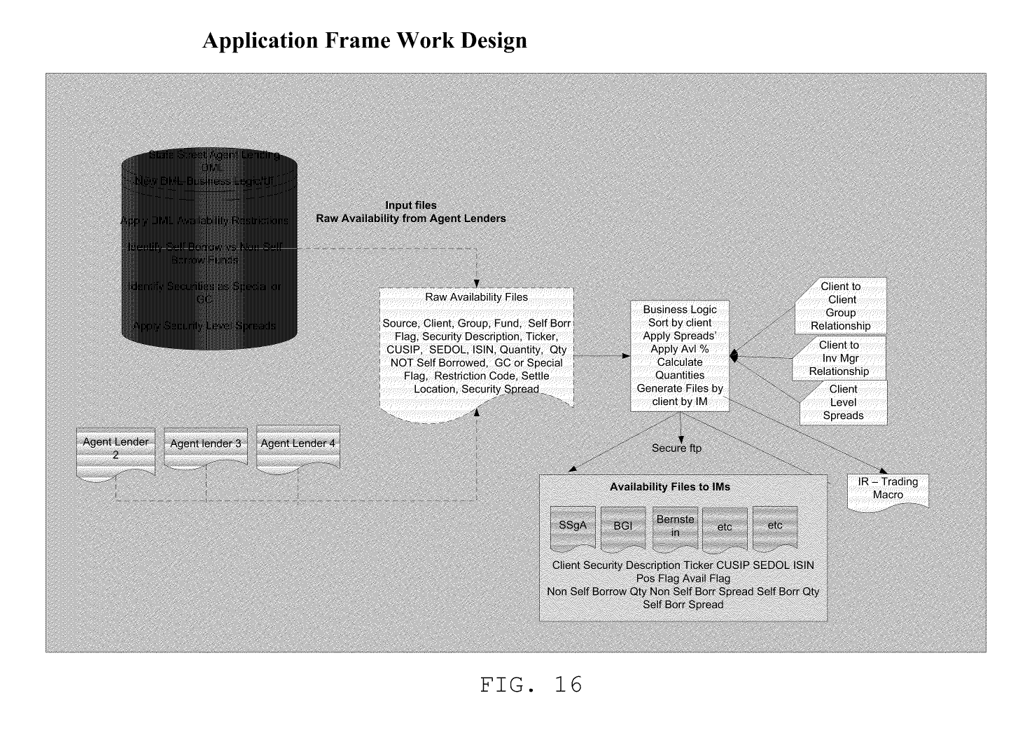

FIG. 16 describes the application framework design. Availability files are collected from various agent lenders. The files contain information, for example, on the source, the client, the group, the fund, whether this is a self-borrow, the security description, Ticker, CUSIP, SEDOL, and ISIN information, quantity information, quantity that is not self-borrowed, whether this is General Collateral (GC) or Special Collateral, the description code, the settle location, and the security spread. Quantities are calculated and files are generated based on, fore example, business logic, client sorting, spreads, or alternative vehicle investment percentages, client to client group relationships, client to investment manager relationships, and client level spreads. The availability files are then sent securely to investment managers for GC.

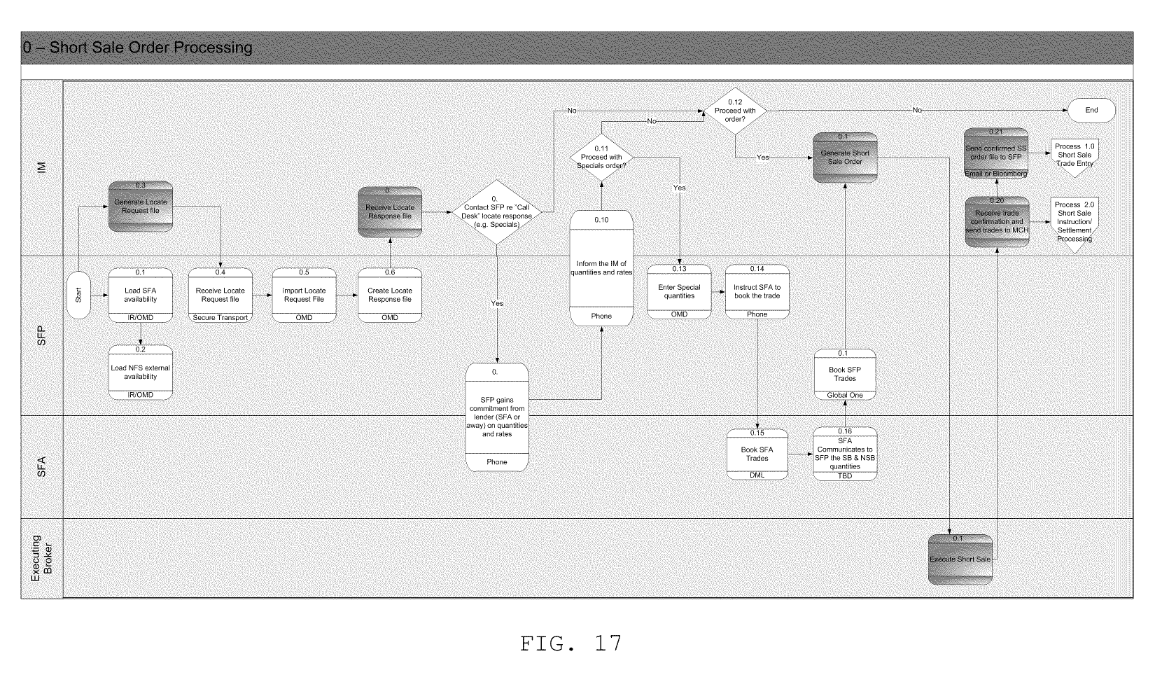

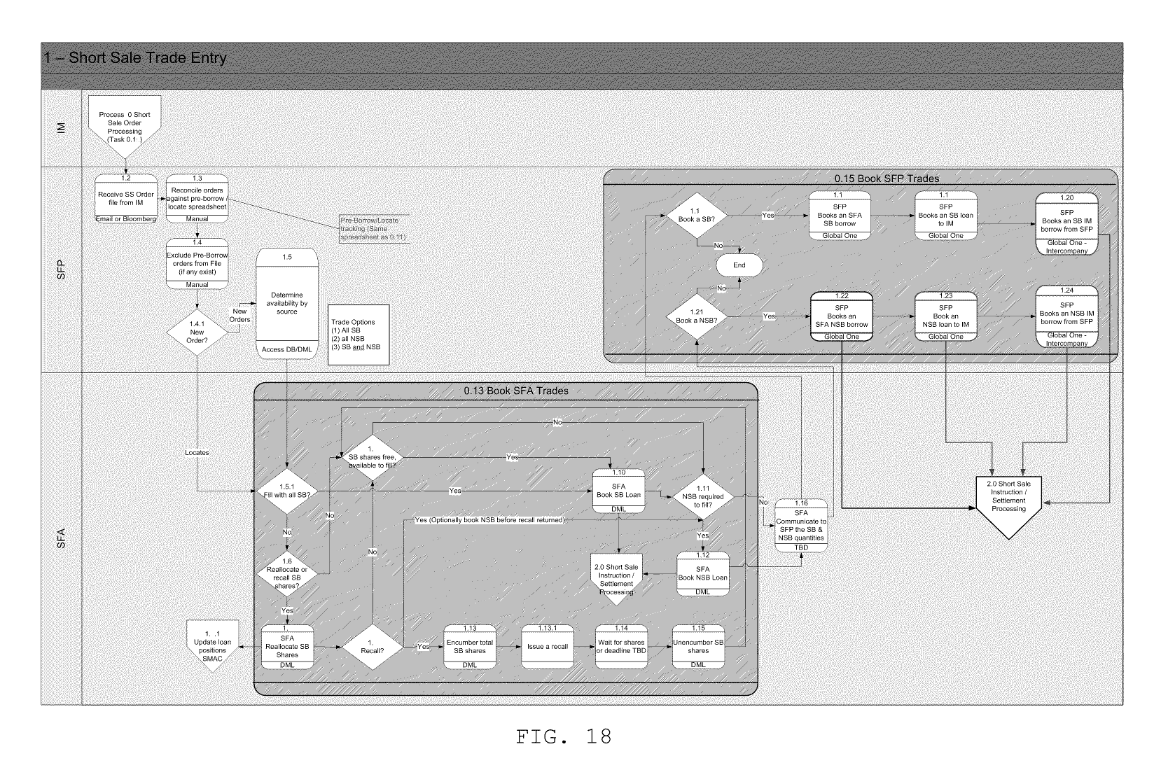

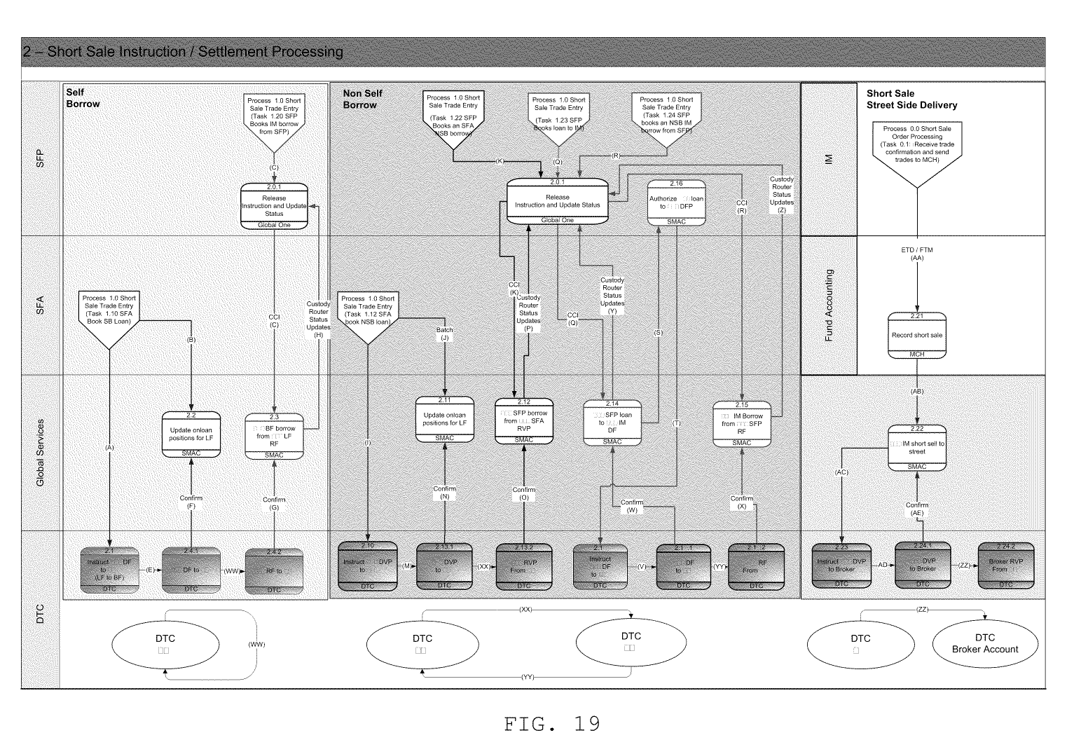

FIG. 17 shows the process of a short sale order. Specifically, at step 0.3 a locate request file is generated. The SFP receives the locate request and sends back to the investment manager a locate response file. The investment manager may have the option to communicate with the SFP to inquire about quantities and rates for the order. The SFP in response, may inform the investment manager of the available quantities and rates, generating a special order. The investment manager may chose to proceed with the special order. In such case, the SFP instructs the SFA to book the SFA trades and communicate the SFP the quantities. The SFP trades are communicated to the investment manager who may choose whether to proceed or not with the generation of the short sale order. The short sale order of the borrowed securities is executed by an executing broker. The investment manager receives the trade confirmation, sends the trades to MCH and initiates a short sale instruction/settlement process as described in FIG. 19 or sends the confirmed short sale order file to the SFP and initiates a short sale trade entry as described in FIG. 18. The process shown on FIG. 17 makes sure that the security is delivered to the investment manager, so that on settlement day the investment manager has the security to make a delivery.

FIG. 18 shows the process for short sale trade entries after a short sale has been ordered. The short sale trade entry ensures the delivery of the specific security. Initially, the agent lender receives the order file, either by the locate process or by the phone, from the investment manager and performs reconciliations to ensure that the requests are matched with the executions, so that investment manager does not borrow too much. The trades can be booked at the agent lender as shown in the 0.13 Book SFA Trades sub-process or at the finance principal as shown in the 0.15 Book SFT Trades sub-process.

According to an embodiment of the present invention, the agent lender is able to perform self-borrowing of securities. For example, an encumbered selling may relate to a pension plan that may have fifteen different funds being one legal entity. One of those funds may be a long-short fund, while the other can be a long-only fund. If the long-only fund holds the security that long-short fund has, the agent lender will take the security from the long-only fund and move it to the long-short fund. The transfer from one fund to the other is performed to cover the short sell. This self-borrowing process is cheaper for clients, because the agent lender only charges an administration fee and does not need to put up any collateral. If the security is self-borrowed, then it is transferred inside from one fund to another to cover the short sell. If the security is not self-borrowed then it is a loan that is going to be booked. The agent lending desk books the loan, lends it to the principal in the FSC side and the Global One system records the borrowing from the principal and the lending to the client. On the account settlement date, the securities are ready to be moved and delivered to the client's account.

FIG. 19 shows a short sale instruction or settlement process, according to embodiments of the present invention. This process reports when all the borrowing is complete and everything is booked and also sends instructions to the bank's custody system for making the deliveries. Specifically, the assets are sitting in the lending client's account and they need to be borrowed and transferred to the AIV's account. FIG. 19 shows both the self-borrow and the non-self borrow processes. In the non-self-borrow case, the securities are moving from agent lending (DTC 997) to principal lending (DTC 998), shown as “(XX)”, and then are moved back to agent lending, shown as (“YY”). In the self-borrow case, the securities are moved within agent lending, shown as “(WW).”

The agent lender takes the securities from the custody system and moves them into the principal system on the lending side. Then the agent lender moves them back to the client's account sitting in custody. Therefore, the securities are moved back to the same place, but this is done for two different clients at the agent lender. The principal always sits in the middle of every transaction. The process also includes confirmations that the securities have been moved into the client's account, so that they can make the short-sale delivery.

In the non self-borrow case, the principal obviates the need for the lender to approve the borrower. Further, there is no need for the borrowers to communicate directly with the lenders. The lending clients need only approve the principal. The principal may perform risk analysis on the lenders and feel comfortable to lend the securities to the lender.

In the self-borrow case, movements of securities between the funds can be disclosed since funds are within the same legal entity, since the movements are just internal transfers staying within the lending agent and they don't have to move through the principal.

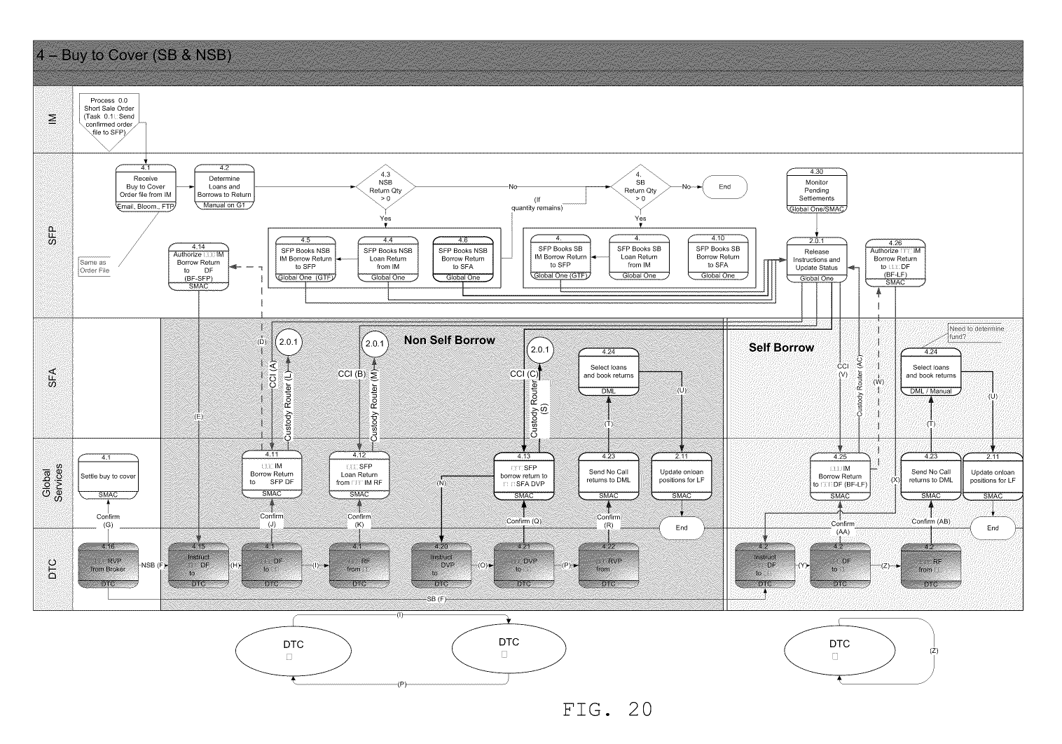

FIG. 20 describes a buy-to-cover process. After a client has borrowed a security and has done a short sell, they can decide to take any profit they have made by buying the security. When the buy-to-cover settles the borrowed securities are returned back to the agent lending program. In the non self-borrow case, the securities are returned to the principal and the principal delivers them back to the agent lending desk. In the self-borrow case, the securities are returned to the original fund within the legal entity.

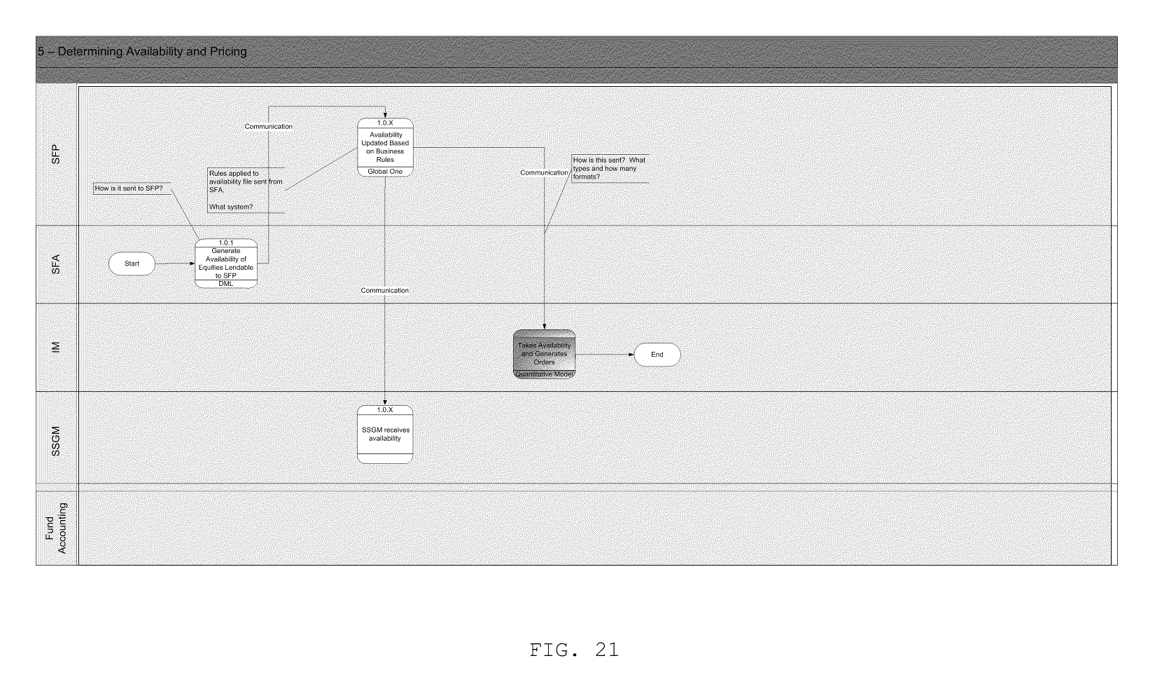

FIG. 21 shows a process to communicate to the investor managers the availability of the equities to be lent to the principal. Investor managers may check the availability before the send locate requests.

When a client wants to initiate a short sell that is worth, for example, $100,000, a typical broker-dealer will do a margin call and require an amount of equities or cash greater than $100,000 for collateral to perform the short sell. In the case the broker-dealers require equities, when they take control of those equities, they own those equities including marketing and corporate actions and dividends. Additionally, broker-dealers can lend them to another client, put them on the street and raise cash, while the client is not aware.

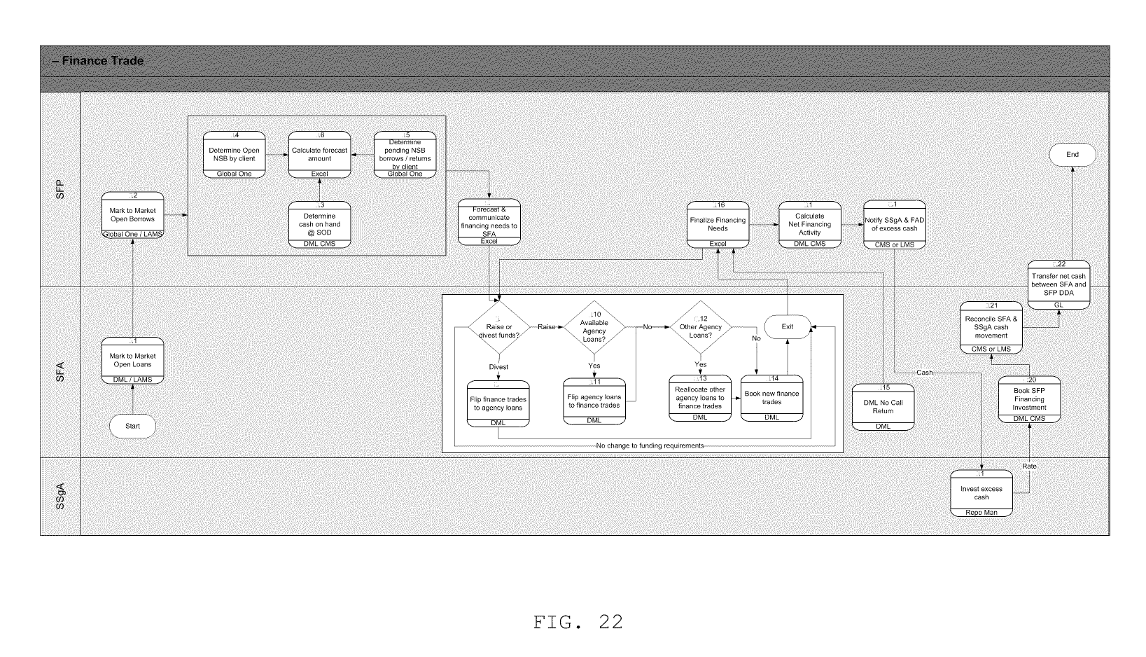

FIG. 22 describes how a trade is financed according to embodiments of the present invention, when clients do not have any cash to provide as collateral. In such case, the lending agent and the client work jointly to raise the collateral, for example, by utilizing long equities. The agent lender lends the long equities and for every lending you collect cash collateral. In a traditional agent lending program, that cash would get invested trying to make the spread, paying back to the broker versus the profit of the investment. In the disclosed agent lending program, that cash is not invested but it is returned to the client who gives it to the principal to pay for the borrowed securities. This is a considerably cheaper way of financing compared to a broker-dealer system. Additionally, there is transparency involved in every loan put for financing. Moreover, many clients prefer getting cash for the equities lending.

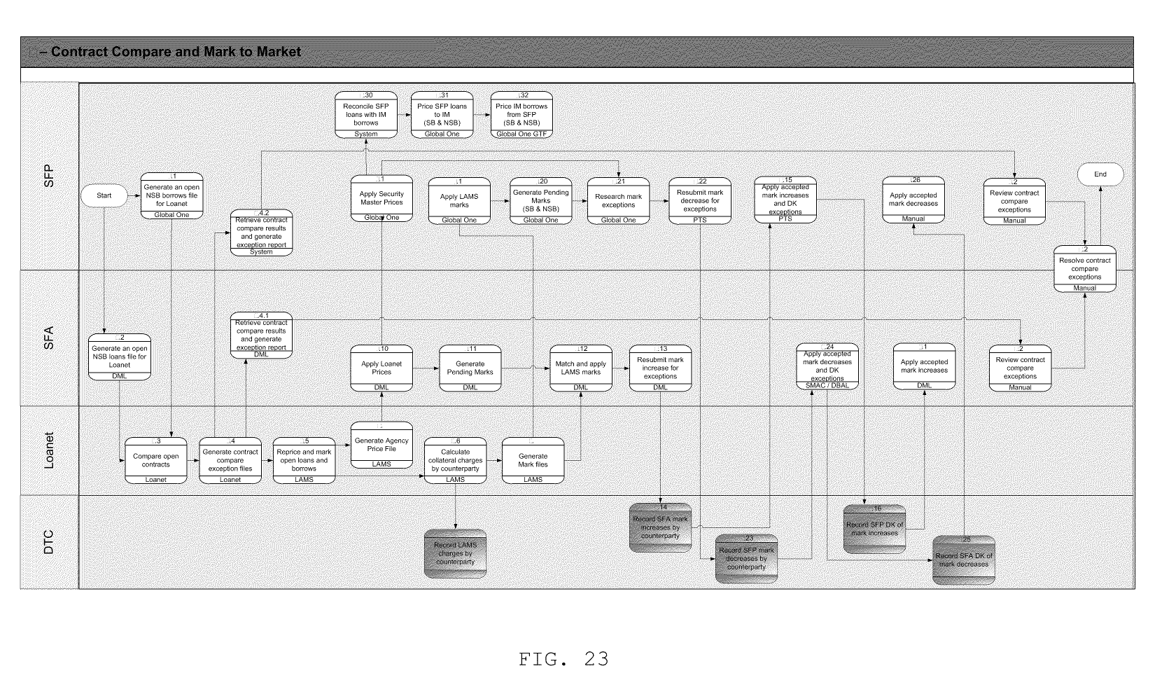

FIG. 23 shows a contract compare and mark to market process. In FIG. 23, “Loanet” is a contract compare service provider and “LAMS” is a low-net automated mark system. Assuming that the agent lending investor is the lender and the principal investor is the borrower, every night contracts are compared to make sure that contracts are booked the same way and they are synchronized. Additionally, according to embodiments of the present invention, once the contracts are compared, marks are generated on both sides, those marks providing information, for example, that the securities are moving in the price that were borrowed. For example, assuming that every day a certain collateral has to be kept, and the price of the security dropped from the lent price of the previous day, the client can collect some cash back. The client can mark the agent lending desk and get the cash back. If the next day the price goes up, the agent lending desk can do a mark and request some cash back. “Loanet” can automate the collateral level, for example, to be at 102%.

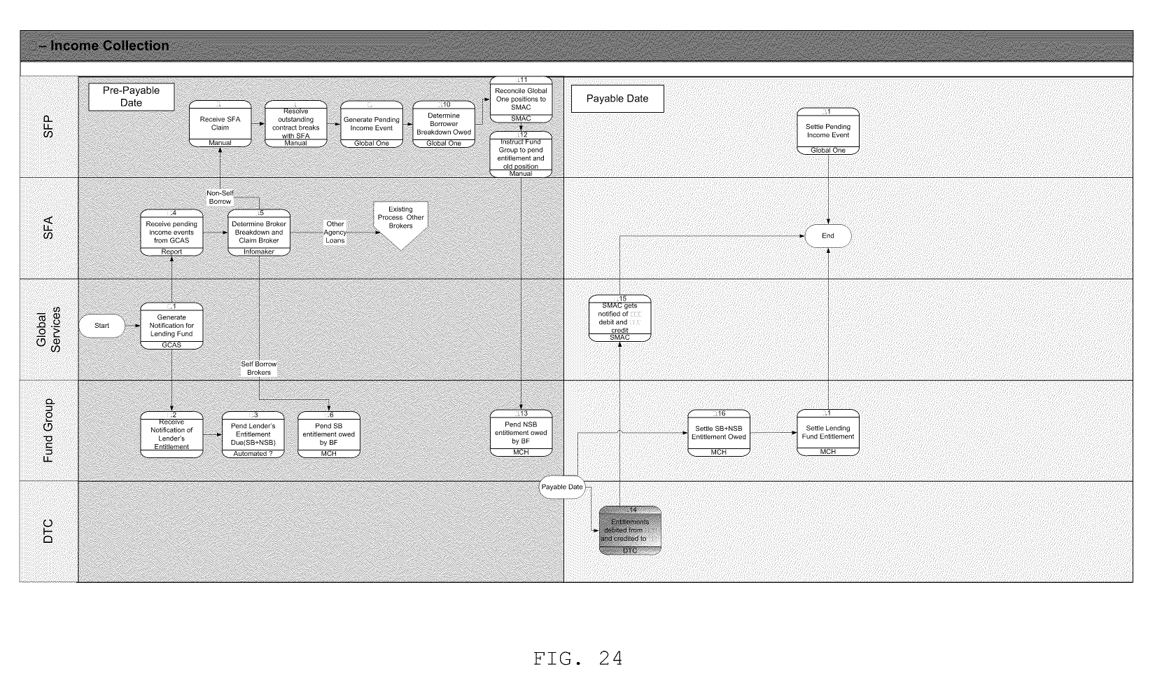

FIG. 24 shows an income collection process (dividends), involving on the payable date settling pending income events, lending fund entitlements, debits from the principal, and credits from the agent lender.

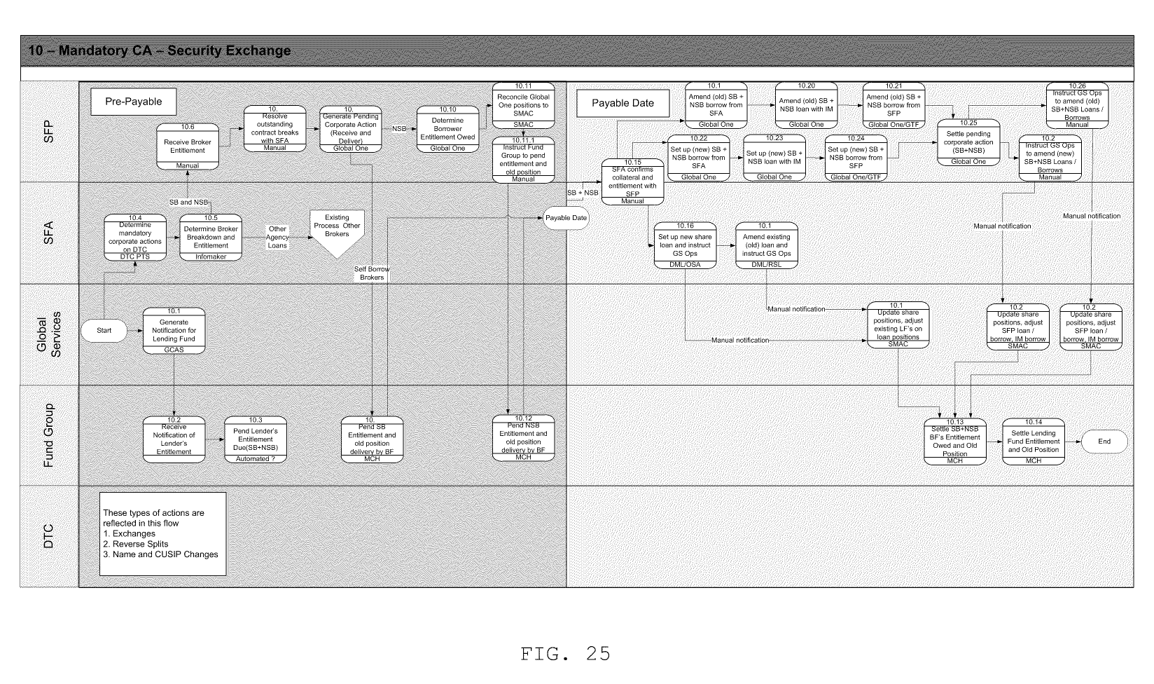

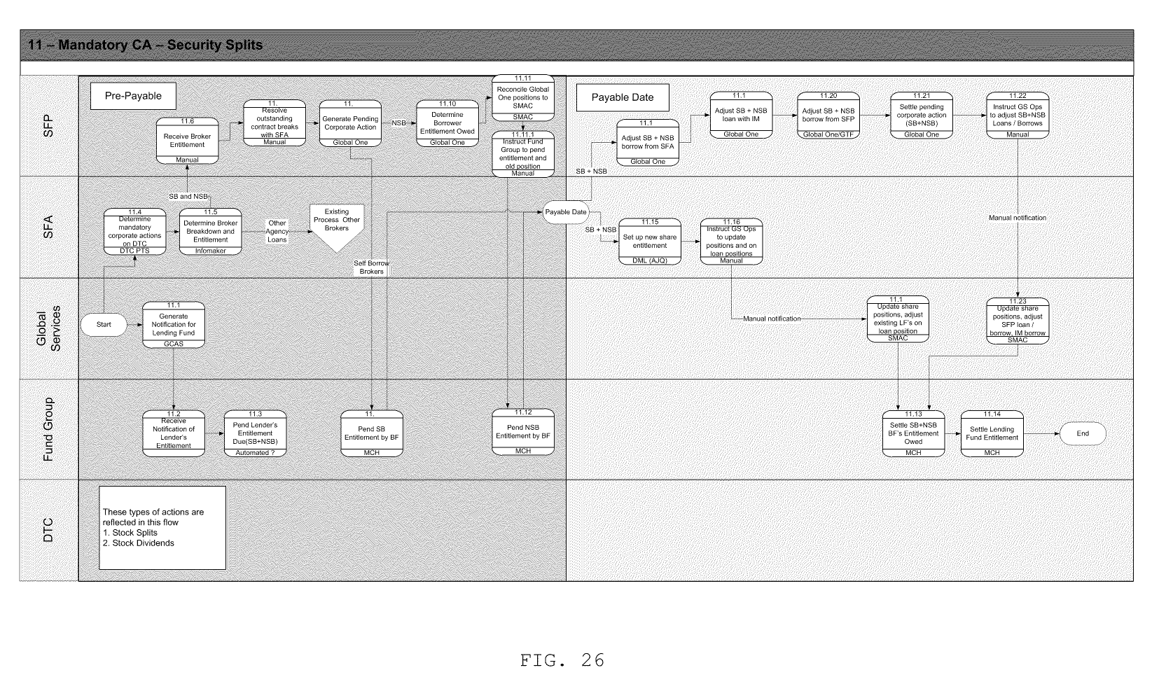

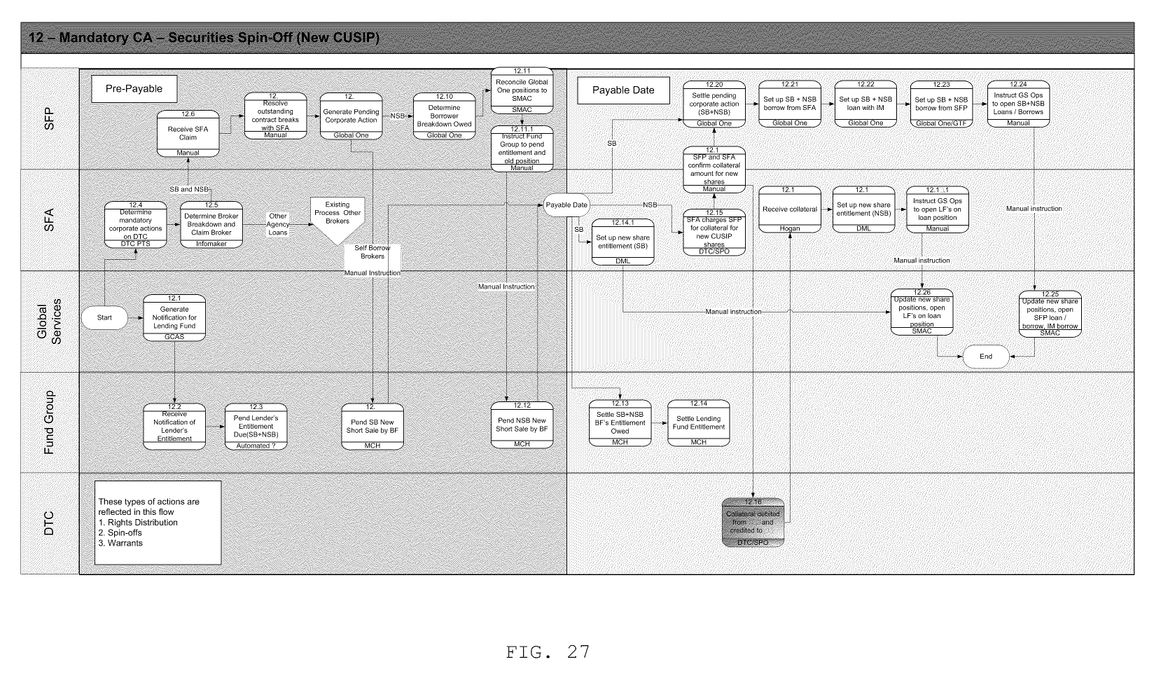

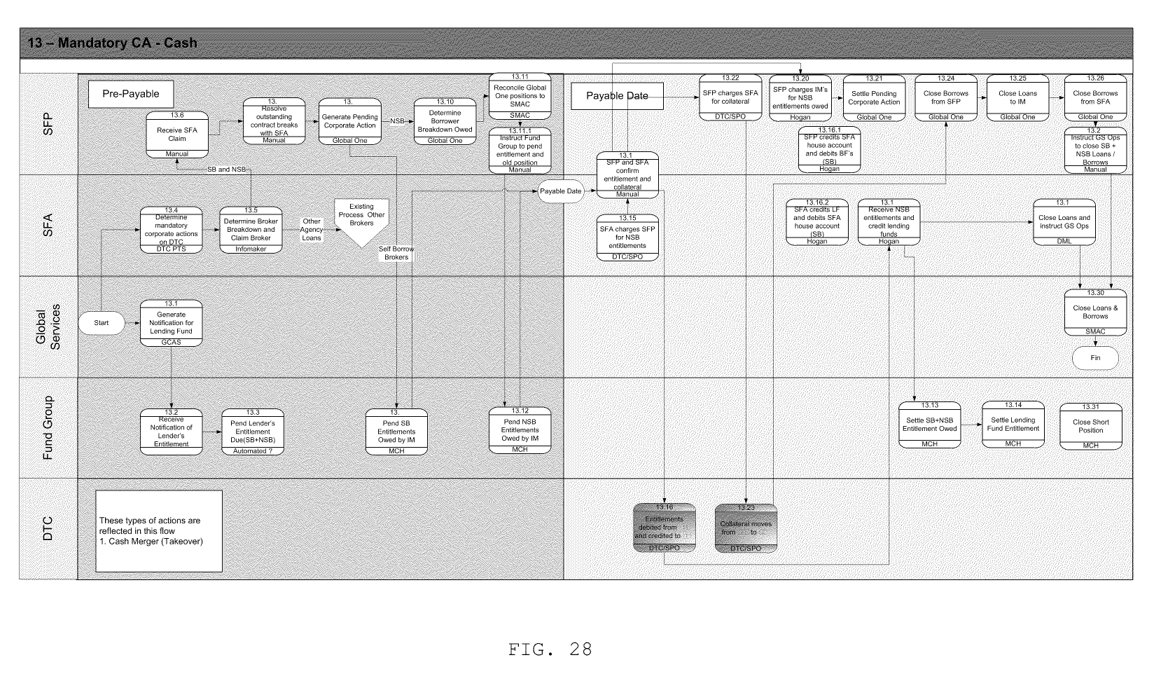

FIGS. 25-28 show mandatory corporate action processes. Global Services is a custody group, which manages the corporate actions. Specifically, FIG. 25 describes a mandatory corporate action involving a security exchange. The types of actions reflected may include exchanges, reverse splits, or name and CUSIP changes. FIG. 26 describes a mandatory corporate action involving security splits. The types of actions reflected may include stock splits or stock dividends. FIG. 27 describes a mandatory corporate action involving security spin offs, being assigned a new CUSIP. The types of actions reflected may include rights distributions, spin-offs, or warrants. FIG. 28 describes a mandatory corporate action involving cash. The action reflected may include cash mergers (takeovers).

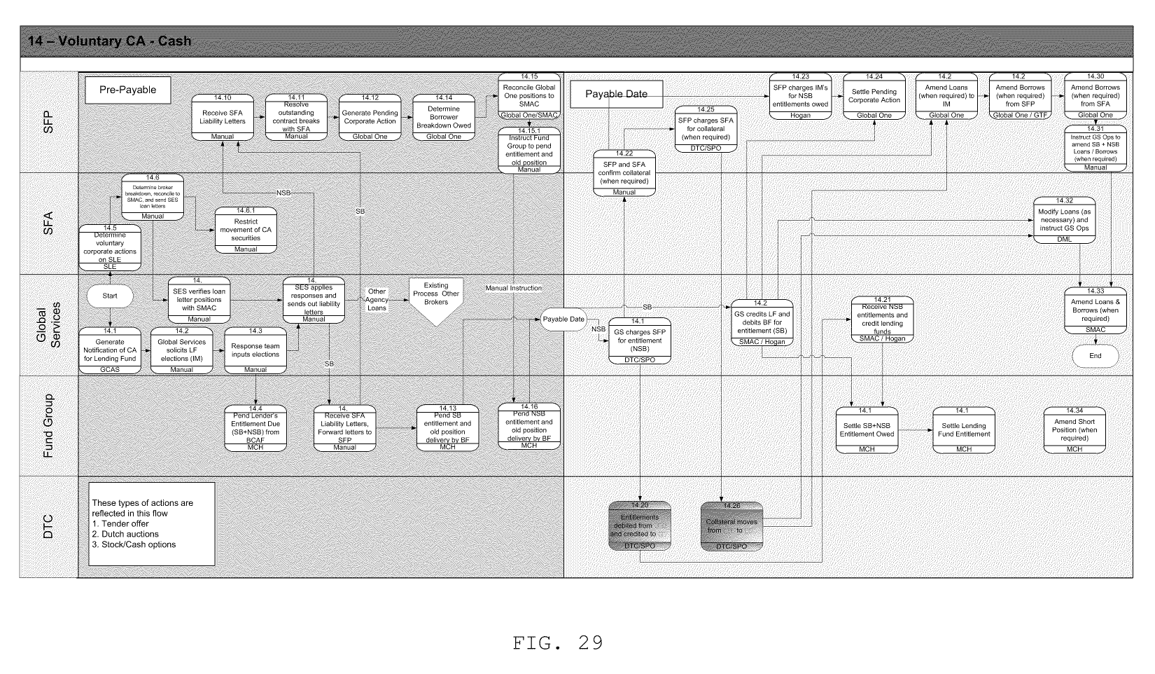

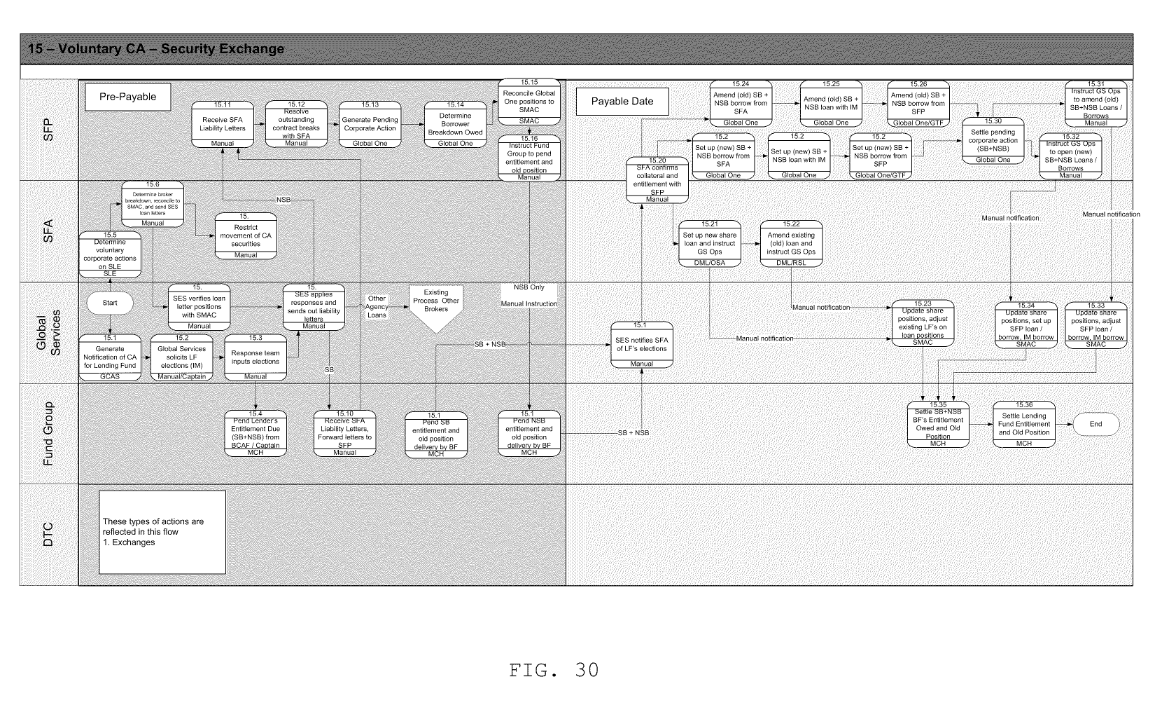

In voluntary corporate action, shown in FIGS. 29 and 30, the client is able to make a choice as to the type of corporate action they want to take. Clients may choose a voluntary corporate action involving either cash (FIG. 29) or security exchange (FIG. 30). The lending agent will then act accordingly to the client's choice, so that the borrower has no option.

It will be also be understood that the detailed description herein may be presented in terms of program procedures executed on a computer or network of computers. These procedural descriptions and representations are the means used by those skilled in the art to most effectively convey the substance of their work to others skilled in the art.

A procedure is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to these quantities.

Further, the manipulations performed are often referred to in terms, such as adding or comparing, which are commonly associated with mental operations performed by a human operator. No such capability of a human operator is necessary, or desirable in most cases, in any of the operations described herein which form part of the present invention; the operations are machine operations. Useful machines for performing the operation of the present invention include general purpose digital computers or similar devices.

The present invention also relates to apparatus for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove more convenient to construct more specialized apparatus to perform the required method steps. The required structure for a variety of these specific machines will appear from the description provided above.

The system according to the invention may include a general purpose computer, or a specially programmed special purpose computer. The user may interact with the system via e.g., a personal computer or over PDA, e.g., the Internet an Intranet, etc. Either of these may be implemented as a distributed computer system rather than a single computer. Similarly, the communications link may be a dedicated link, a modem over a POTS line, the Internet and/or any other method of communicating between computers and/or users. Moreover, the processing could be controlled by a software program on one or more computer systems or processors, or could even be partially or wholly implemented in hardware.

Although a single computer may be used, the system according to one or more embodiments of the invention is optionally suitably equipped with a multitude or combination of processors or storage devices. For example, the computer may be replaced by, or combined with, any suitable processing system operative in accordance with the concepts of embodiments of the present invention, including sophisticated calculators, hand held, laptop/notebook, mini, mainframe and super computers, as well as processing system network combinations of the same. Further, portions of the system may be provided in any appropriate electronic format, including, for example, provided over a communication line as electronic signals, provided on CD and/or DVD, provided on optical disk memory, etc.

Any presently available or future developed computer software language and/or hardware components can be employed in such embodiments of the present invention. For example, at least some of the functionality mentioned above could be implemented using JAVA, Visual Basic, C, C++ or any assembly language appropriate in view of the processor being used. It could also be written in an object oriented and/or interpretive environment such as Java and transported to multiple destinations to various users.

It is to be understood that the invention is not limited in its application to the details of construction and to the arrangements of the components set forth in the foregoing description or illustrated in the drawings. For example, one or more systems described above may be used in the enhanced securities lending process. Accordingly, it will be understood that the invention is capable of other embodiments and of being practiced and carried out in various ways. Also, it is to be understood that the phraseology and terminology employed herein are for the purpose of description and should not be regarded as limiting. It should also be noted that, while some embodiments described above may currently not be approved under federal or other relevant regulations, these embodiments are nevertheless considered to be part of the present invention.

Those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The many features and advantages of the embodiments of the present invention are apparent from the detail specification, and thus, it is intended to cover all such features and advantages of the invention that fall within the true spirit and scope of the invention. All suitable modifications and equivalents maybe resorted to, falling within the scope of the invention.

The invention claimed is:

1. A computer-implemented method for executing a principal lending transaction for securities managed by an entity, to lend the securities from lending accounts of the entity to borrowing accounts of the entity, in which the entity acts as a principal in the transaction, the method comprising:
electronically transmitting securities availability information from the principal lending computer system indicating availability of the securities available for borrowing from lending accounts of the entity;
electronically receiving a short sale indication of a security for a borrowing account;
electronically transmitting a first transfer instruction to the custody-control computer system to transfer custody of the shorted security from at least one lending account to the principal; and
electronically transmitting a second transfer instruction to the custody-control computer system to transfer custody of the shorted security from the principal to the borrowing account.

2. The computer-implemented method of claim 1, wherein the short sale indication is received after the short sale by monitoring a trading computer system to detect short sales by borrowing accounts.

3. The computer-implemented method of claim 1, wherein the short sale indication is received before the short sale as a borrow request identifying a security to be borrowed based on the securities availability information.

4. The computer-implemented method of claim 3, wherein the borrow request is received from an investment manager for the borrowing account.

5. The computer-implemented method of claim 1, wherein the step of electronically transmitting securities availability information comprises:
electronically receiving a securities locate request identifying securities sought for borrowing; and
electronically transmitting a securities locate request response indicating availability of the securities sought for borrowing.

6. The computer-implemented method of claim 5, wherein the securities locate request is received from an investment manager for the borrowing account.

7. The computer-implemented method of claim 1, wherein the lending account and the borrowing account both belong to the same client of the entity.

8. The computer-implemented method of claim 1, wherein the securities availability information is stored in the principal lending computer system based on information from lending accounts seeking to participate in principal lending transactions.

9. The computer-implemented method of claim 8, wherein the information from lending accounts seeking to participate in principal lending transactions is received from a lending agent of the entity.

10. The computer-implemented method of claim 1, further comprising initiating a lending transaction of long securities held by the borrowing account to a broker to obtain cash collateral for principal lending transaction.

11. The computer-implemented method of claim 1, wherein the electronically transmitting the second transfer instruction to the custody-control computer system to transfer custody of the shorted security from the principal to the borrowing account results in proceeds of sale of the borrowed security being transmitted to the borrowing account.

12. The computer-implemented method of claim 11, wherein the electronically transmitting the second transfer instruction to the custody-control computer system to transfer custody of the shorted security from the principal to the borrowing account results in proceeds of sale of the borrowed security being transmitted to the borrowing account allowing the client to initiate a purchase of securities for the borrowing account using the sale proceeds to fill in a long position of the client.

13. A system for executing a principal lending transaction for securities managed by an entity, to lend the securities from lending accounts of the entity to borrowing accounts of the entity, in which the entity acts as a principal in the transaction, the system comprising:
a computer database configured to store securities availability information indicating availability of the securities available for borrowing from lending accounts of the entity; and
a computer server system implemented by a principal lending computer system connected to the computer database, the principal lending computer system being configured to receive a short sale indication of a security for a borrowing account,
wherein the principal lending computer system is further configured to electronically transmit a first transfer instruction to the custody-control computer system to transfer custody of the shorted security from at least one lending account to the principal, and electronically transmit a second transfer instruction to the custody-control computer system to transfer custody of the shorted security from the principal to the borrowing account.

14. The system of claim 13, wherein the short sale indication is received after the short sale by monitoring a trading computer system to detect short sales by borrowing accounts.

15. The system of claim 13, wherein the short sale indication is received before the short sale as a borrow request identifying a security to be borrowed based on the securities availability information.

16. The system of claim 15, wherein the borrow request is received from an investment manager for the borrowing account.

17. The system of claim 13, wherein the electronically transmitting securities availability information by the computer server system comprises:
electronically receiving a securities locate request identifying securities sought for borrowing; and
electronically transmitting a securities locate request response indicating availability of the securities sought for borrowing.

18. The system of claim 17, wherein the securities locate request is received from an investment manager for the borrowing account.

19. The system of claim 13, wherein the lending account and the borrowing account both belong to the same client of the entity.

20. The system of claim 13, wherein the securities availability information is stored in the principal lending computer system based on information from lending accounts seeking to participate in principal lending transactions.

21. The system of claim 20, wherein the information from lending accounts seeking to participate in principal lending transactions is received from a lending agent of the entity.

22. The system of claim 13, wherein the system initiates a lending transaction of long securities held by the borrowing account to a broker to obtain cash collateral for principal lending transaction.

23. The system of claim 13, wherein proceeds of sale of the borrowed security are transmitted to the borrowing account when the system electronically transmits the second transfer instruction to the custody-control computer system to transfer custody of the shorted security from the principal to the borrowing account.

24. The system of claim 23, wherein proceeds of sale of the borrowed security are transmitted to the borrowing account allowing the client to initiate a purchase of securities for the borrowing account using the sale proceeds to fill in a long position of the client when the system electronically transmits the second transfer instruction to the custody-control computer system to transfer custody of the shorted security from the principal to the borrowing account.

25. A computer-implemented method for executing a principal lending transaction for securities managed by an entity, to lend the securities from lending accounts of the entity to borrowing accounts of the entity, in which the entity acts as a principal in the transaction, the method comprising:
enabling electronically transmitting securities availability information from the principal lending computer system indicating availability of the securities available for borrowing from lending accounts of the entity;
enabling electronically receiving a short sale indication of a security for a borrowing account;
enabling electronically transmitting a first transfer instruction to the custody-control computer system to transfer custody of the shorted security from at least one lending account to the principal; and
enabling electronically transmitting a second transfer instruction to the custody-control computer system to transfer custody of the shorted security from the principal to the borrowing account.
